(19) United States
(12) Patent Application Publication
(10) Pub. No.: US 2004/0163041 A1
(43) Pub. Date: Aug. 19, 2004

(54) Relational database structures for structured documents

(75) Inventor: Alan K. Engel, Villanova, PA (US)

Correspondence Address: ELMAN TECHNOLOGY LAW, P.C., P. O. BOX 209, SWARTHMORE, PA, 19081-0209, US

(73) Assignee: Paterra, Inc.

(21) Appl. No.: 10/367,296

(22) Filed: Feb. 13, 2003

(51) Int. Cl. G06F 15/00

(52) U.S. Cl. 715/509; 715/513

(57) ABSTRACT

Textual elements and unambiguous locations paths corresponding to textual elements and/or their ancestors are extracted from a tree-structured document such as an XML document and stored in relational database structures. Textual elements are stored in a table comprising a column of textual elements and an identity column. The unambiguous location paths are stored in a second table in rows comprising the location path, the identity form the first table corresponding to the first textual element that is a descendant of the location path, the identity from the first table corresponding to the last textual element that is a descendant of the location path, and the name of the element located by the location path.

A portion of the disclosure of this patent document contains material which is subject to copyright protection. The copyright owner has no objection to the facsimile reproduction by anyone of the patent disclosure, as it appears in the PTO patent file or records, but otherwise reserves all copyright rights whatsoever. Copyright © 2003 Paterra, Inc.

### TECHNICAL FIELD

This invention relates to the storage and representation of tree-structured documents, particularly XML documents, in a relational database. In particular, this invention relates to the storage of unambiguous location paths extracted from tree-structured documents in a relational database.

### DEFINITIONS

“Tree-structured document” shall mean a document whose entities are properly nested, in other words, no entity begins in one entity and ends in another.

“Extensible markup language” and “XML” shall mean the ‘“Extensible Markup Language (XML) 1.0 (Second Edition): W3C Recommendation 6 Oct. 2000, ” http://www.w3.org/TR/2000/REC-xml-20002006 (hereinafter, “W3C XML”). These terms shall also apply to markup languages based on this W3C Recommendation and their conformant variations and specializations.

“Relational database” shall mean a database in which tables can be related by keys as described in Codd, E. F. “A Relational Model of Data for Large Shared Data Banks,” Communications of the ACM, Vol. 13, No. 6, Jun. 1970, pp. 377-387 (hereinafter, “Cobb”). The relational database model stores data in relations and enables the developer to simply describe what data are required, not how to obtain the data. Those skilled in the art will appreciate that the nomenclature of the field uses a number of terms synonymously. For example, the “relations” of Codd are synonymous with the “tables” of this disclosure. Other literature uses “tuples” to refer to “rows” as they are used in this disclosure.

“Updategram” is an XML document that can be used to update SQL databases. This includes those described by Burke et al. for updating Microsoft's SQL Server 2000 relational database system using Microsoft's XML extender, XML for SQL Server Web Release 1 (Burke, Paul J. et al. (2001). Professional SQL Server XML. Birmingham: Wrox Press Ltd. Chapter 9. Updategrams, hereinafter “Burke et al”). It also includes UpdateGrams as provided in OpenLink's Virtuoso Server for updating Microsoft SQL Server, Oracle or IBM's DB2 databases.

Definition of Location Path and Unambiguous Location Path

“Location Path”

Location paths are expressions for locating a node of interest in a tree-structured document. In particular, they are expressions in a query language for locating a node of interest in a tree-structured documents.

The XML System uses a subset of Extensive Stylesheet Language Transformation (XSLT) and XML Path Language (XPath), Version 1.0, the W3C working draft of Nov. 16, 1999, to identify XML elements or attributes. The content of the XPath is originally in the XSLT and now it is referred to by XSLT as a part of the stylesheet transformation language. Previously, the term “path expression” was used. Now, a subset of the term location path is used in XSLT and XPath to define XML elements and attributes. The XSLT XPath's abbreviated syntax of the absolute location path is used.

The following is not a formal data model, but a set of abbreviated syntax. An absolute location path with abbreviated syntax is listed below. Again, these are not formal definitions.

a. “/”.

Represents the XML root element.

b. “/tag1”:

Represents the element tag1 under root.

c. “/tag1/tag2/ . . . /tagn”:

Represents an element with the name tagn as the child with the descending chain from root, tag1, tag2, . . . , tagn−1

d. “//tagn”

Represents any element with the name tagn, where “//” denotes zero or more arbitrary tags.

e. “//tag1//tagn”

Represents any element with the name tagn which is a child of element with the name tag1 under root, where “//” denotes zero or more arbitrary tags.

f. “/tag1/tag2/@attr1”

Represents the attribute attr1 of element with the name tag2 as a child of element tag1 under root.

g. “/tag1 /tag2/[@attr1=“5”]”

Represents the element with the name tag2 whose attribute attr1 has the value 5 and it is a child of element with the name tag1 under root.

h. “/tag1/tag2/[aattr1=“5”]/ . . . /tagn”

Represents the element with the name tagn which is a child of the descending chain from root, tag1, tag2, . . . where the attribute attr1 of tag2 has the value ‘5 ’.

i. “/tag1/tag2/tag3”=“Los Angeles”/ . . . /tagn”

Represents the element with the name tagn which is a child of the descending chain from root, tag1, tag2, . . . where tag3 has the value “Los Angeles”.

j. “/tag1/tag2/*[@attr1=“5”]”

Represents all elements as children of element “/tag1/tag2” with attr1 of value “5”.

“Unambiguous Location Path”

An unambiguous location path is a location path that specifies one and only one element in the document. With the exception of a. above (W3C XML allows one root in an XML document), all of the above location paths may be ambiguous. In other words, there may be multiple elements in the document that satisfy each of the above location paths. The unambiguous location path requirement is satisfied by including the position( ) function in the location path. Examples are the following:

a./descendant::figure[position( )=n]

Represents, in unabbreviated syntax, the nth figure element in the document.

b. /doc/chapter[m]/section[n]

Represents, in abbreviated syntax, the nth section of the mth chapter of doc.

### BACKGROUND ART

In recent years, the saving of structured documents or fragments thereof in databases has become an active area of development.

Christophides et al (1994) disclose a mapping of SGML nodes to classes in an object-oriented database management system together with a query language based on generalized path expressions.

Lee et al (2002) disclose three semantics-based algorithms for transforming XML data into relational format and vice versa.

Kappel et al. (2000) present an approach to storing XML documents in relational database systems wherein the structure of XML documents in terms of a DTD is mapped to a corresponding relational schema and XML documents are stored according to the mapping.

Muench (2002) teaches that Oracle Corporation's interMedia software can save XML documents or fragments in CLOB (Character-based Large OBject) columns for fulltext indexing. As exemplified by FIG. 13-2 on page 517 of Muench (2000), an XML document is saved into database structures in which the XML element tagnames either correspond to the names of tables or columns in the database, or are embedded in CLOB columns. Muench (2000) does not disclose the storage of XML location paths in database columns either explicitly or implicitly as part of an equivalent structure.

Oracle Corporation (2001) likewise teaches that XML documents can be stored in Oracle 9i relational database as generated XML, CLOB columns or a hybrid of the two. Oracle9i Case Studies—XML Applications, Release 1 (9.0.1), June 2001, p.1-4 teaches that XML can be stored in the Oracle 9i relational database as “decomposed” XML documents in which the XML data is stored in object relational form or as composed or “whole” XML documents in which the XML data is stored in XMLType or CLOB/BLOB columns. It does not disclose the storage of XML location paths in database columns. Ennser et al (2000) similarly teach that XML documents can be stored in IBM's DB2 relational database as either XML columns in which the entire XML document is stored in a column or as XML collections in which XML documents are decomposed into database tables. However, the storage of XML location paths in database columns is not disclosed.

U.S. patent application Ser. No. 20020078068A1 discloses a method and apparatus for flexible storage and uniform manipulation of XML data in a relational database system in which XML documents are stored in a table named after the root document, said table containing an XMLType column that contains the entire document and a set of hidden columns named for descendant elements of the root document. It does not disclose the storage of XML location paths in database columns.

U.S. patent application Ser. No. 20020103829A1 discloses a method, system, program and data structures for managing structured documents in a database. It does not disclose the storage of XML location paths in database columns. Nor does it disclose a table in each row that relates an element and its location path to the textual objects (strings) that are descendant to said element.

Japan Unexamined Patent Publication 2000-122903A discloses a method for mapping structured information such as an XML document into database tables. However, it does not disclose the storage of location path as columns in the database tables.

Japan Unexamined Patent Publication 2001-34513A discloses a mapping of element names in an XML document to table names, element attribute names to column names and textual children of the elements to columns in a relational database. However, it does not disclose the storage of location path in columns in the database tables.

Japan Unexamined Patent Publication 2001-34619A discloses the mapping of an XML document onto a tree structure with the intermediate nodes of the tree corresponding to the XML elements, attribute nodes of the tree corresponding to attributes of their respective elements and leaf nodes of the tree corresponding to the values of their respective elements. This publication further disclosing the mapping of the tree onto database tables consisting of an intermediate node table, a link table, a leaf node table, an attribute node table, a path ID table and a label (tagname) table. The path ID table contains distinct lists of intermediate nodes. These lists are not XPath location paths nor are they XSL location paths. More importantly, they are not absolute location paths and do not, by themselves, allow the unambiguous specification of a leaf node.

Japan Unexamined Patent Publication 2001-236352A discloses a method for querying an XML document using an SQL style query. However, it does not disclose the storage or representation of XML documents in a relational database.

Japan Unexamined Patent Publication 2001-331479A discloses an object relational model representation for XML documents. However, it does not disclose the storage of location path as a column in database tables.

In U.S. Pat. No. 6,366,934, Cheng et al disclose an extender for indexing XML documents stored in CLOB columns in a relational database. However, it does not disclose the storage of location path as a column in database tables.

U.S. patent application Ser. No. 20020156772A1 discloses a method, apparatus and article of manufacture for indexing XML documents stored in an XML column in a database by creating side tables containing data from the documents and a location path-based means for locating indexed data in the respective document. However, it does not disclose the storage of location paths, and particularly unambiguous location paths, in a column in a table in the database. Rather, the above application discloses the prior storage of location paths in a Document Access Definition (DAD), which defines the mapping of side tables to XML documents. The DAD, as defined by the Document Type Definition disclosed in paragraph [0126] of the above application, discloses the location path as an attribute in an element definition, “<!ELEMENT column EMPTY><!ATTLIST column name CDATA #REQUIRED type CDATA #IMPLIED path CDATA #IMPLIED multi₁₃ occurrence CDATA #IMPLIED>.” In other words, the disclosed location paths are disclosed as attributes of elements in the DAD that relate columns in the database to elements in the XML documents stored in an XML column.

U.S. patent application Ser. No. 20020133484A1 discloses a technique for creating metadata for fast search of XML documents stored in an XML column in a database by creating side tables containing data from the documents and a location path-based means for locating indexed data in the respective document. However, it does not disclose the storage of location paths, and particularly unambiguous location paths, in a column in a table in the database. Rather, the above application discloses the prior storage of location paths in a Document Access Definition (DAD), which defines the mapping of side tables to XML documents. The DAD, as defined by the Document Type Definition disclosed in paragraph [0136] of the above application, discloses the location path as an attribute in an element definition, “<!ELEMENT column EMPTY><!ATTLIST column name CDATA #REQUIRED type CDATA #IMPLIED path CDATA #IMPLIED multi_occurrence CDATA #IMPLIED>.” In other words, the disclosed location paths are disclosed as attributes of elements in the DAD that relate columns in the database to elements in the XML documents stored in an XML column.

U.S. patent application 20020123993A1 discloses a technique for creating metadata for fast search of XML documents stored in an XML column in a database by creating side tables containing data from the documents and a location path-based means for locating indexed data in the respective document. However, it does not disclose the storage of location paths, and particularly unambiguous location paths, in a column in a table in the database. Rather, the above application discloses the prior storage of location paths in a Document Access Definition (DAD), which defines the mapping of side tables to XML documents. The DAD, as defined by the Document Type Definition disclosed in paragraph [0133] of the above application, discloses the location path as an attribute in an element definition, “<!ELEMENT column EMPTY><!ATTLIST column name CDATA #REQUIRED type CDATA #IMPLIED path CDATA #IMPLIED multi_occurrence CDATA #IMPLIED>.” In other words, the disclosed location paths are disclosed as attributes of elements in the DAD that relate columns in the database to elements in the XML documents stored in an XML column.

U.S. Pat. No. 6,421,656 discloses a method and apparatus for creating structure indexes for a database extender wherein the user can define an indexing mechanism based on a list of “structure paths.” However, it does not disclose the storage of location paths in a column in a database.

Problem

Conventional storage schemes for structured documents are difficult to apply to general XML documents. Storage in CLOB columns does not take advantage of the structured nature of XML documents. Decomposing the XML document requires prior knowledge of its structure and the development of a corresponding database schema.

### SUMMARY OF THE INVENTION

The objective of this invention is to provide a method of storing data from at least one tree-structured document in a data store connected to a computer, the method comprising the extraction of unambiguous location paths from said tree-structured documents; and the insertion of said location paths into a table.

It is a further objective of this invention is to provide a method for extracting and storing unambiguous location paths from documents written in one or a plurality of extensible markup languages.

A further objective of this invention is to provide a method of storing unambiguous locations paths, that have been extracted from one or a plurality of tree-structured documents, into a data store by forming one or a plurality of intermediate documents that conform to a database extender application and applying said intermediate documents to the database extender.

A further objective of this invention is to provide the above method storing unambiguous locations paths, that have been extracted from one or a plurality of tree-structured documents, into a data store by forming one or a plurality of intermediate documents that conform to a database extender application and applying said intermediate documents to the database extender, wherein the database extender is Microsoft Corporation's XML for SQL Server and the data store is Microsoft Corporation's SQL Server database application.

A further objective of this invention is to provide a method of storing unambiguous locations paths, that have been extracted from one or a plurality of tree-structured documents, into a data store by forming one or a plurality of intermediate SQL script documents.

Another objective of this invention is to provide a method of storing data from at least one tree-structured document in a data store connected to a computer, the method comprising extracting textual elements from said tree-structured document together with unambiguous location paths corresponding to said textual elements, and inserting said textual elements into one column of a table and location paths into a second column that is in a one-to-one relationship to the first column.

A further objective of this invention is to provide a method for extracting and storing textual elements and unambiguous location paths from documents written in one or a plurality of extensible markup languages

A further objective of this invention is to provide a method of extracting and storing textual elements and unambiguous location from one or a plurality of tree-structured documents wherein the textual elements and corresponding location paths are stored as rows in a single table.

A further objective of this invention is to provide a method of extracting and storing textual elements and unambiguous location from one or a plurality of tree-structured documents wherein the textual elements and corresponding location paths are stored in separate tables that are in a one-to-one relationship by means of a key.

A further objective of this invention is to provide a method of storing textual elements and unambiguous locations paths, that have been extracted from one or a plurality of tree-structured documents, into a data store by forming one or a plurality of intermediate documents that conform to a database extender application and applying said intermediate documents to the database extender.

A further objective of this invention is to provide the above method of storing textual elements and unambiguous locations paths, that have been extracted from one or a plurality of tree-structured documents, into a data store by forming one or a plurality of intermediate documents that conform to a database extender application and applying said intermediate documents to the database extender, wherein the database extender is Microsoft Corporation's XML for SQL Server and the data store is Microsoft Corporation's SQL Server database application.

Another objective of this invention is to provide a method of storing data from at least one tree-structured document in a data store connected to a computer, the method comprising extracting textual elements from said document together with the unambiguous location paths corresponding to said textual elements and the ancestor elements of said textual elements; inserting said textual elements into one column of a first table that also contains an identity column; and inserting rows into a second table, said rows comprising an unambiguous location path selected from the above unambiguous location paths, the identity of the first textual element that is a descendent of said location path, and the identity of the last textual element that is a descendent of said location path, said identities being the corresponding identities of said textual elements in said first table. A further objective is to provide the forgoing method wherein said rows inserted into said second table additionally comprises the name of the element specified by said location path.

A further objective of this invention is to provide a method for extracting and storing textual elements and unambiguous location paths from documents written in one or a plurality of extensible markup languages wherein the textual elements are inserted into a first table that also has an identity column; and the location paths into a second table that also has an identity column, a column that contains the identifier of the first textual element that is a descendent of the corresponding location path and a column that contains the identifier of the last textual element that is a descendent of the corresponding location path.

A further objective of this invention is to provide a method for extracting and storing textual elements and unambiguous location paths from tree-structured documents in a way that also stores identifiers for the first and last textual elements that are descendents of the corresponding location path, wherein intermediate documents are formed that conform to a database extender and these documents are applied to the database extender. A further objective is to provide this method wherein the database extender is Microsoft Corporation's XML for SQL Server and the data store is Microsoft Corporation's SQL Server database application.

Another objective of this invention is to provide a method of storing data from at least one tree-structured document in a data store connected to a computer, the method comprising extracting textual elements from said document together with unambiguous location paths corresponding to said textual elements and ancestor elements of said textual elements; inserting unambiguous location paths corresponding to said textual elements into one column of a first table that also contains an identity column; and inserting rows into a table, said rows comprising an unambiguous location path selected from the above unambiguous location paths, the identity of the location path in the first table that corresponds to the first textual element that is a descendent of said location path, and the identity of the location path in the first table that corresponds to the last textual element that is a descendent of said location path. A further objective is to provide the forgoing method wherein said rows inserted into said second table additionally comprises the name of the element specified by said location path.

### DESCRIPTION OF DRAWINGS

FIG. 1 depicts a typical hardware and operating environment in which the current invention can be implemented.

FIG. 2A depicts a generic XML document from which database tables can be derived according to the Preferred Embodiment.

FIG. 2B depicts a string table according to the Preferred Embodiment.

FIG. 2C depicts a location path table according to the Preferred Embodiment.

FIG. 2D depicts a string-element table according to the Preferred Embodiment.

FIG. 2E shows an SQL query that can be part of a search request according to the Preferred Embodiment.

FIG. 3 schematically depicts a method for inserting textual strings from an XML document into database tables according to the Preferred Embodiment.

FIG. 4A depicts a generic XML document from which database tables can be derived according to Alternate Embodiment 1.

FIG. 4B depicts a string table according Alternate Embodiment 1.

FIG. 4C depicts a location path table according to Alternate Embodiment 1.

FIG. 4D depicts a string-element table according to Alternate Embodiment 1.

FIG. 4E depicts an element code table according to Alternate Embodiment 1.

FIG. 5A depicts a generic XML document from which database tables can be derived according to Alternate Embodiment 2.

FIG. 5B depicts a string table according Alternate Embodiment 2.

FIG. 5C depicts a location path table according to Alternate Embodiment 2.

FIG. 5D depicts a string-element table according to Alternate Embodiment 2.

FIG. 6A depicts a generic XML document from which database tables can be derived according to Alternate Embodiment 3.

FIG. 6B depicts a string table according Alternate Embodiment 3.

FIG. 6C depicts a location path table according to Alternate Embodiment 3.

FIG. 7A depicts a generic XML document from which database tables can be derived according to Alternate Embodiment 4.

FIG. 7B depicts a string table according Alternate Embodiment 4.

FIG. 7C depicts a location path table according to Alternate Embodiment 4.

FIG. 7D depicts an updategram according to Alternate Embodiment 4.

FIG. 8A depicts a generic XML document from which database tables can be derived according to Alternate Embodiment 5.

FIG. 8B depicts a string table according Alternate Embodiment 5.

FIG. 8C depicts a location path table according to Alternate Embodiment 5.

FIG. 9A depicts a generic XML document from which database tables can be derived according to Alternate Embodiment 6.

FIG. 9B depicts a string table according Alternate Embodiment 6.

FIG. 9C depicts a location path table according to Alternate Embodiment 6.

FIG. 10A depicts a generic XML document from which database tables can be derived according to Alternate Embodiment 7.

FIG. 10B depicts a string table according Alternate Embodiment 7.

FIG. 11A depicts a generic XML document from which database tables can be derived according to Alternate Embodiment 9.

FIG. 11B depicts a string table according Alternate Embodiment 9.

FIG. 11C depicts a location path table according to Alternate Embodiment 9.

FIG. 11D depicts a string-element table according to Alternate Embodiment 9.

FIG. 11E depicts an attribute table according to Alternate Embodiment 9.

FIG. 12 depicts a method for storing data extracted from an XML document in a relational database.

FIG. 13 is a flowchart showing the process executed by the gatherstrings template shown in FIG. 12.

FIG. 14A depicts a generic XML document from which database tables can be derived according to Alternate Embodiment 10

FIG. 14B depicts a location path table according to Alternate Embodiment 10

FIG. 14C depicts an element table according to Alternate Embodiment 10

FIG. 15A depicts a generic XML document from which database tables can be derived according to Alternate Embodiment 11

FIG. 15B depicts a string path table according to Alternate Embodiment 11

FIG. 15C depicts a location path table according to Alternate Embodiment 11

FIG. 15D depicts a string-element table according to Alternate Embodiment 11

FIG. 16 schematically depicts a method for inserting textual strings from an XML document into database tables according to Alternate Embodiment 12.

FIG. 17 depicts a method for storing data extracted from an XML document in a relational database according to Alternate Embodiment 12.

### DISCLOSURE OF INVENTION

Hardware and Operating Environment

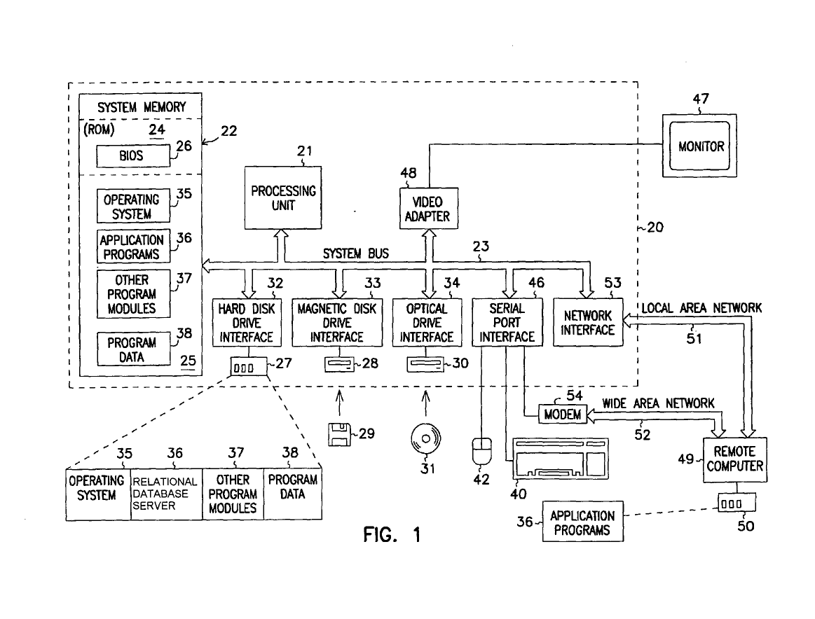

FIG. 1 provides a brief, general description of a suitable computing environment in which the invention may be implemented. The invention will hereinafter be described in the general context of computer-executable program modules containing instructions executed by a personal computer (PC) or server computer. Program modules include routines, programs, objects, components, data structures, etc. that perform particular tasks or implement particular abstract data types. Those skilled in the art will appreciate that the invention may be practiced with other computer-system configurations, including hand-held devices, multiprocessor systems, microprocessor-based programmable consumer electronics, network PCs, minicomputers, mainframe computers, and the like which have multimedia capabilities. The invention may also be practiced in distributed computing environments where tasks are performed by remote processing devices linked through a communications network. In a distributed computing environment, program modules may be located in both local and remote memory storage devices.

FIG. 1 shows a general-purpose computing device in the form of a conventional personal computer/server 20, which includes processing unit 21, system memory 22, and system bus 23 that couples the system memory and other system components to processing unit 21. System bus 23 may be any of several types, including a memory bus or memory controller, a peripheral bus, and a local bus, and may use any of a variety of bus structures. System memory 22 includes read-only memory (ROM) 24 and random-access memory (RAM) 25. A basic input/output system (BIOS) 26, stored in ROM 24, contains the basic routines that transfer information between components of personal computer 20. BIOS 26 also contains start-up routines for the system.

Personal computer/server 20 further includes one or more data stores, such as hard disk drive 27 for reading from and writing to a hard disk (not shown), magnetic disk drive 28 for reading from and writing to a removable magnetic disk 29, and optical disk drive 30 for reading from and writing to a removable optical disk 31 such as a CD-ROM or other optical medium. Hard disk drive 27, magnetic disk drive 28, and optical disk drive 30 are connected to system bus 23 by a hard-disk drive interface 32, a magnetic-disk drive interface 33, and an optical-drive interface 34, respectively. The drives and their associated computer-readable media provide nonvolatile storage of computer-readable instructions, data structures, program modules and other data for personal computer/server 20. Although the exemplary environment described herein employs a hard disk, a removable magnetic disk 29 and a removable optical disk 31, those skilled in the art will appreciate that other types of computer-readable media which can store data accessible by a computer may also be used in the exemplary operating environment. Such media may include magnetic cassettes, flash-memory cards, digital versatile disks, Bernoulli cartridges, RAMs, ROMs, and the like.

Program modules may be stored on the hard disk, magnetic disk 29, optical disk 31, ROM 24 and RAM 25. Program modules may include operating system 35, one or more relational database server programs 36, other program modules 37, and program data 38. A user may enter commands and information into personal computer 20 through input devices such as a keyboard 40 and a pointing device 42. Other input devices (not shown) may include a microphone, joystick, game pad, satellite dish, scanner, or the like. These and other input devices are often connected to the processing unit 21 through a serial-port interface 46 coupled to system bus 23; but they may be connected through other interfaces not shown in FIG. 1, such as a parallel port, a game port, or a universal serial bus (USB). A monitor 47 or other display device also connects to system bus 23 via an interface such as a video adapter 48. In addition to the monitor, personal computers typically include other peripheral output devices (not shown) such as speakers and printers.

Personal computer/server 20 may operate in a networked environment using logical connections to one or more remote computers such as remote computer 49. Remote computer 49 may be another personal computer, a server, a router, a network PC, a peer device, cellular telephone, or other common network node. It typically includes many or all of the components described above in connection with personal computer 20; however, only a storage device 50 is illustrated in FIG. 1. The logical connections depicted in FIG. 1 include local-area network (LAN) 51 and a wide-area network (WAN) 52. Such networking environments are commonplace in offices, enterprise-wide computer networks, intranets and the Internet.

When placed in a LAN networking environment, PC 20 connects to local network 51 through a network interface or adapter 53. When used in a WAN networking environment such as the Internet, PC 20 typically includes modem/router 54 or other means for establishing communications over network 52. Modem/router 54 may be internal or external to PC 20, and connects to system bus 23 via serial-port interface 46. In a networked environment, program modules, such as those comprising Microsoft.RTM. Word which are depicted as residing within 20 or portions thereof may be stored in remote storage device 50. Of course, the network connections shown are illustrative, and other means of establishing a communications link between the computers may be substituted.

The above hardware environment can be expanded to a clustered computer environment using art known to the field.

Tree-Structured Documents

Document specifications that conform to this tree-structured document definition and thus can be mapped to the database structures of this invention are the Extensible Markup Language (XML), XML-based languages and their conformant variations and specializations such as the Extensible Stylesheet Language (XSL), the XSL Transformation Language (XSLT), the Extensible HyperText Markup Language (XHTML), the Java Markup Language (JML), the Source Code Markup Language (SrcML), the Rule Markup Language (RML), the Financial Products Markup Language (FpML), the Wireless Markup Language (WML), the UML eXchange Format (UXF), the Governmental Markup Language (GML), the Bean Markup Language (BML), the Discovery Process Markup Language (DPML), the Web Services Offering Language (WSOL), the Dialog Systems Markup Language (DSML), the Formal Ontology Markup Language (FOML), the Robotics Markup Language (RoboML), the Discourse Plan Markup Language (DPML), the Affective Presentation Markup Language (APML), VoiceXML, the Handheld Device Markup Language (HDML), the Chemical Markup Language (CML), the Mathematical Markup Language (MathML), the Scientific, Technical and Medical Markup Language (STMML), the Computational Chemistry Markup Language (CMLC), and the Geography Markup Language (GML). Those skilled in the art will appreciate that a single document can contain portions in one or a plurality of XML-based languages.

Document specifications that conform to a hierarchical Object Model as defined in Rector, Brent and Sells, Chris. ATL Internals. Addison Wesley Longman, Reading, Mass., 1999, pp.349-355, in which the document can be modeled as a hierarchy of objects, the objects and their subobjects can be manipulated with collections and accessed with enumerators can also be mapped to the database structures of this invention. Examples of such documents include, but are not limited to, the Lisp Abstracted Markup Language (LAML), the Rich Text Format, Microsoft Word documents, HTML 4.0 documents, Microsoft Excel documents, and Microsoft PowerPoint documents.

Relational Database System

The database structures of this invention are implemented in a relational database that follows the design concepts taught in Codd. There are several commercially available software packages that can be used, including but not limited to Watcom SQL, Oracle, Sybase, Access, Microsoft SQL Server, IBM's DB2, AT&T's Daytona, NCR's TeraData and DataCache.

Those skilled in the art will appreciate that many relational database systems provide facilities and structures for improving database performance and that these may be applied to the database structures of this invention without exceeding the scope of this invention. These include, without limitation, indexes,views, indexed views, and materialized views.

Relational Database Tables and Columns According to this Invention

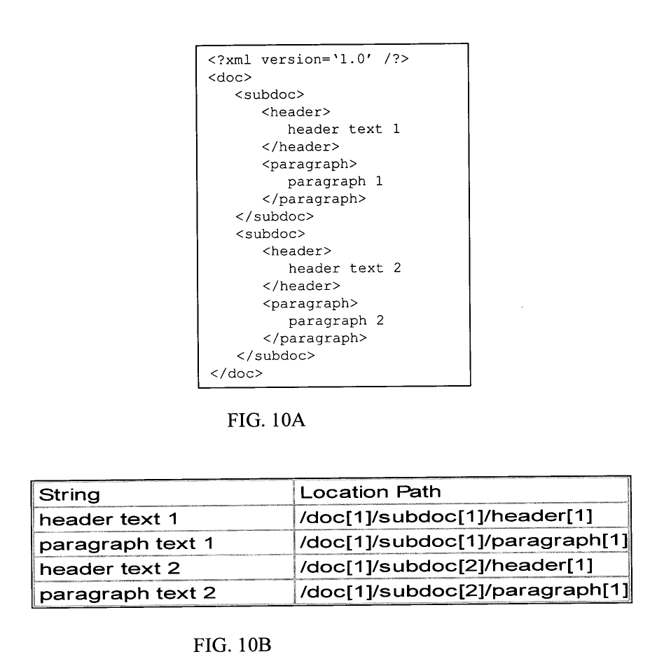

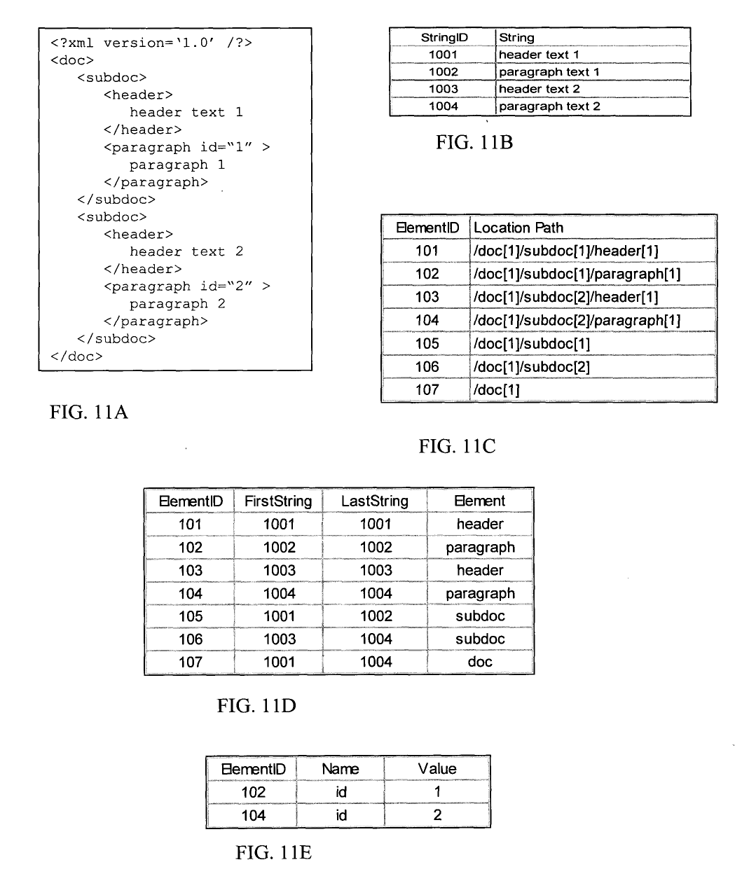

In a simple form, a relational database schema according to this invention comprises one or more tables containing one column containing textual strings extracted from the text elements of an XML document and one column containing location paths corresponding to these strings. FIG. 10 illustrates such a database structure. The location path is defined according to Clark, James; DeRose, Steve; eds. XML Path Language, Version 1.0, World Wide Web Consortium, 1999, and is of sufficient precision as to unambiguously address its corresponding textual element. While those skilled in the art will appreciate that there are several syntaxes that can provide the required precision, the absolute abbreviated location path syntax with enumerated child elements is preferred. For example, the absolute abbreviated location path “/doc[1]/subdoc[1]/header[1]” means the first header child element of the first subdoc child element of the first doc child element of the root.

The data type of the textual string column is preferably variable-length Unicode characters. However, it may also be a CLOB (Character-based Large OBject) or other character or binary data type.

Alternative Embodiment 7 exemplifies this relational database structure according to this invention.

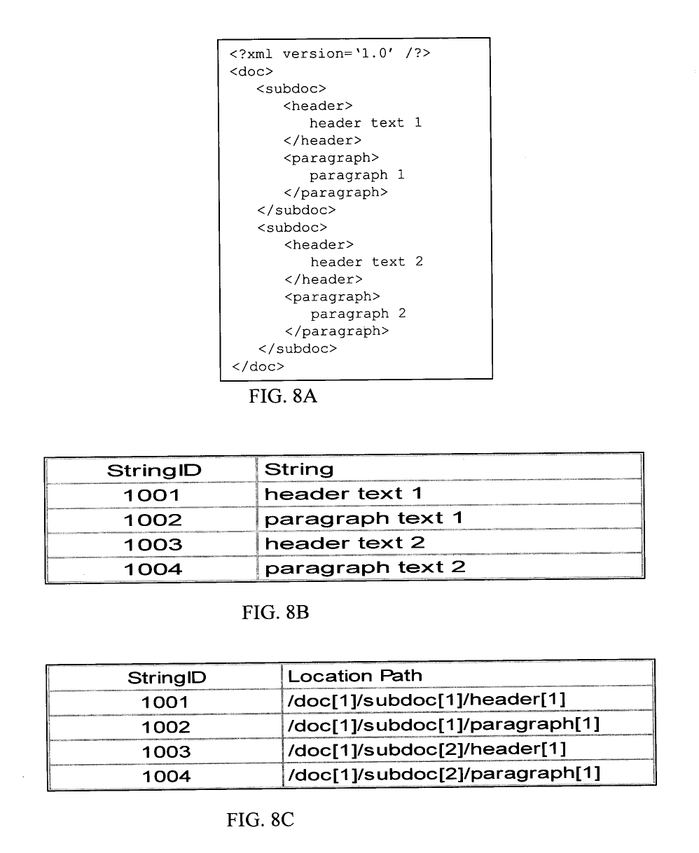

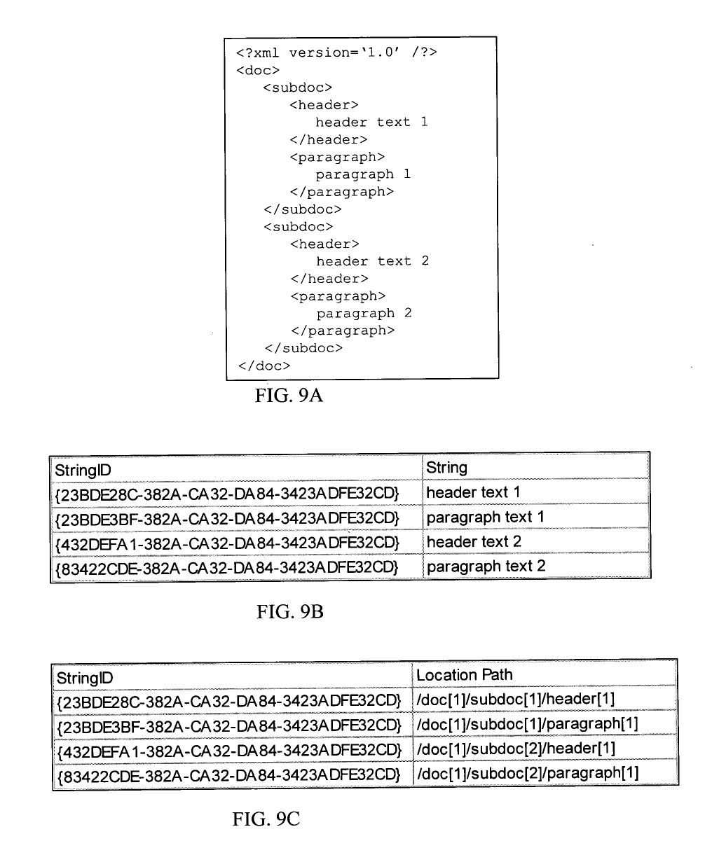

Rather than place the textural string column and location path column in the same table, it is preferable to place them in separate tables that are related by an identity column. This identity column may consist of globally unique identifiers (GUIDs) as shown in FIG. 9 but preferably consists of ordered unique integers as shown in FIG. 8. Those skilled in the art will appreciate that other data types and identity schemes can provide the required uniqueness and preferred ordering.

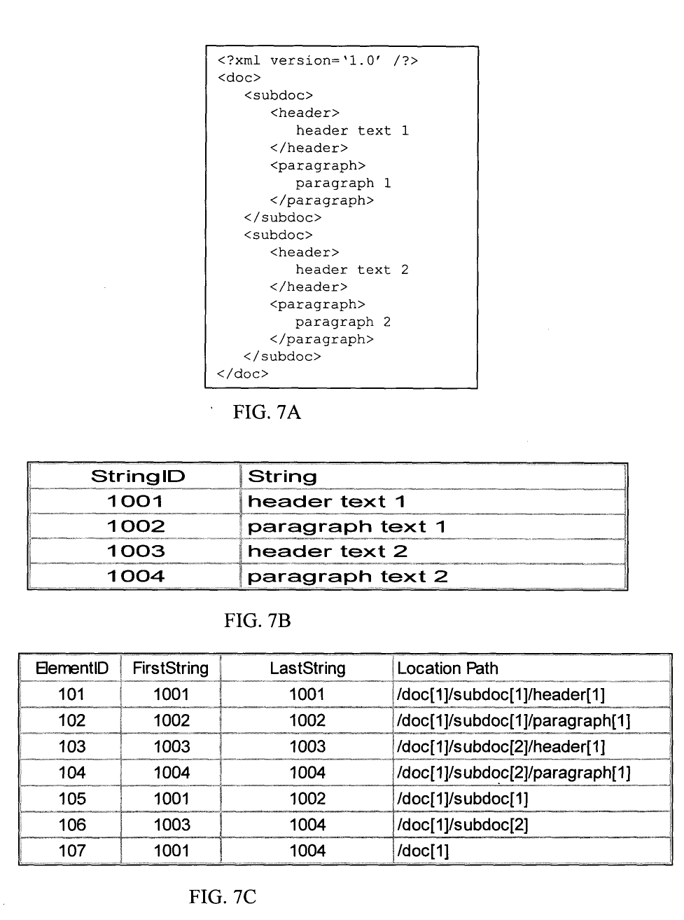

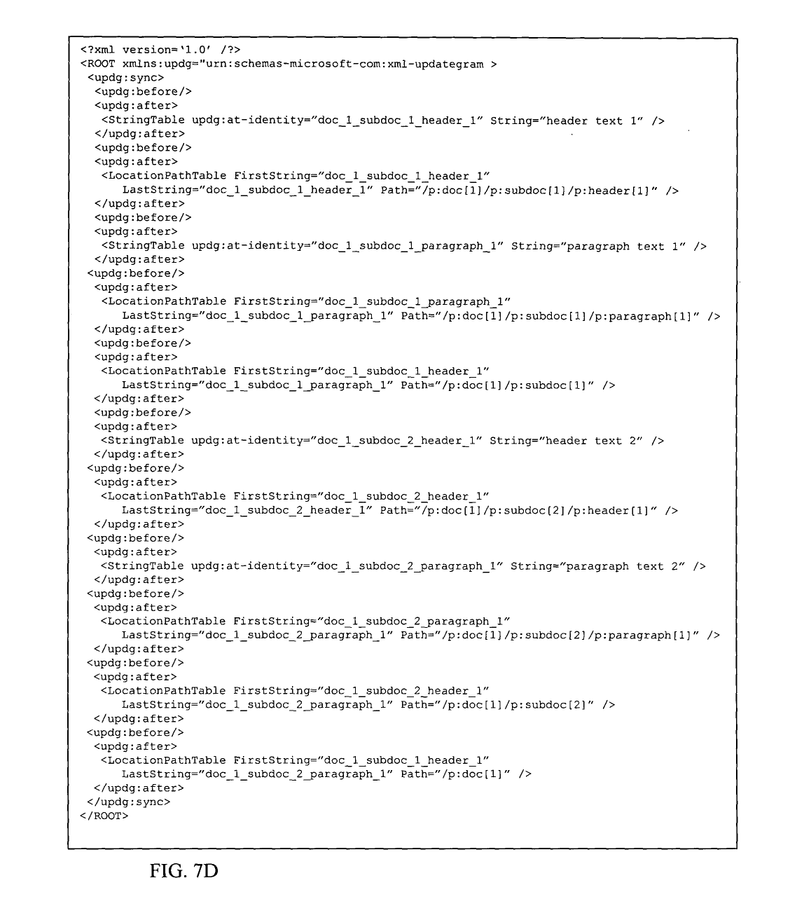

In another relational database schema according to this invention, the location paths are assigned unique identifiers (ElementID) and the identifiers of the first and last of the strings that are descendants of the corresponding location paths are entered into respective columns as shown in FIG. 7. In this schema the unique identifiers for the strings must be ordered. However, those skilled in the art will appreciate that there are data types in addition to the integers shown that will satisfy this ordering requirement. The identifiers of the location paths may be globally unique identifiers (GUIDs) but are preferably ordered identifiers such as integers.

While the first string and last string columns in this schema are included in the location path table as shown in FIG. 7, those skilled in the art will appreciate that there are other essentially equivalent schemas, for example, placing the FirstString and LastString columns in a separate table that is related on the ElementID column.

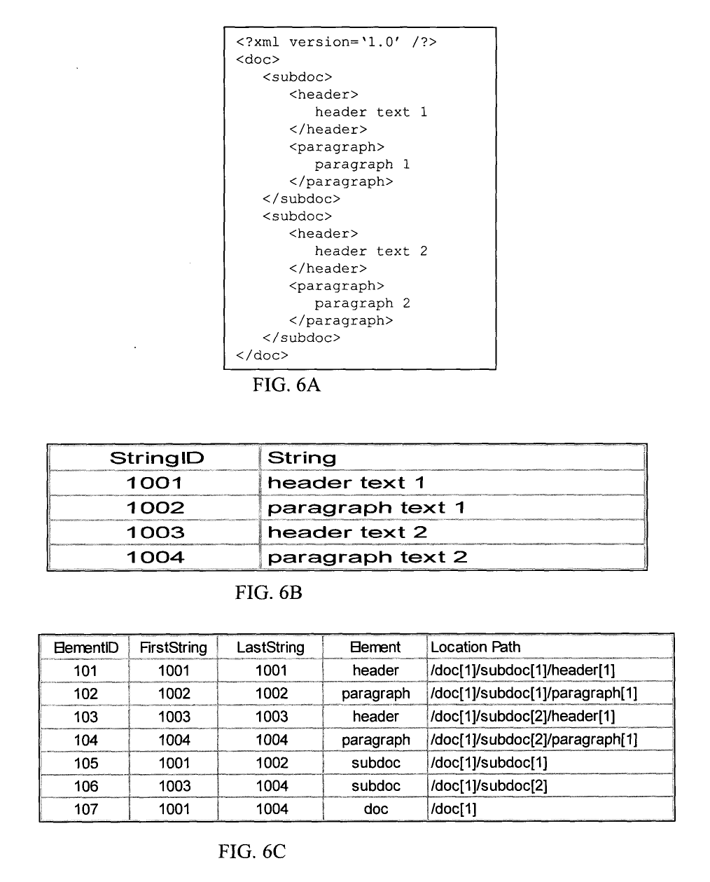

A further relational database schema according to this invention is illustrated in FIG. 6. In this schema an element name column has been added to the location path table shown in FIG. 7. This column consists of the name of the lowest element in the corresponding location path. This element name may, optionally, include a namespace prefix.

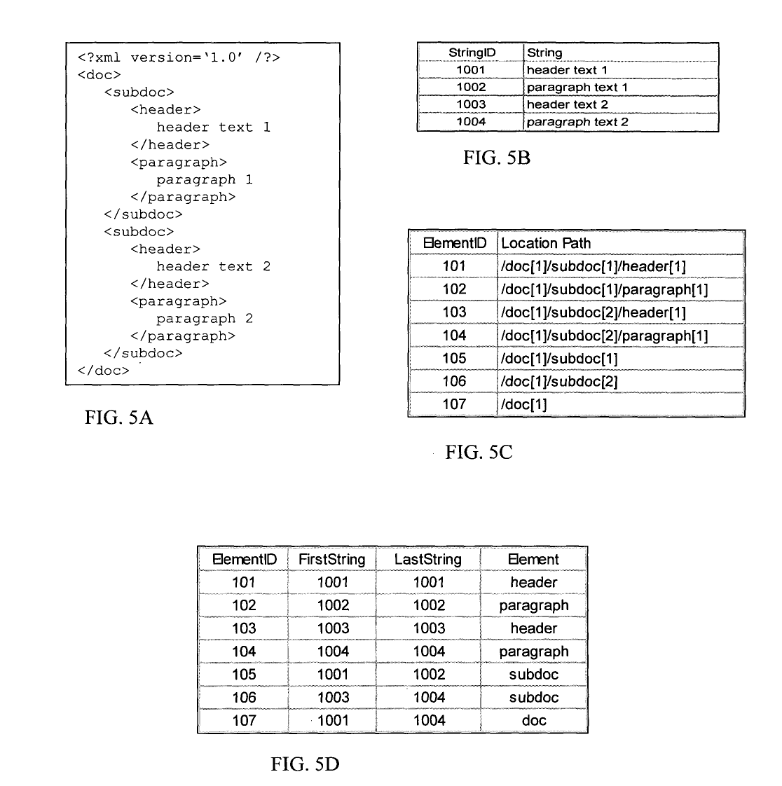

A further relational database schema according to this invention is illustrated in FIG. 5. For this schema, the FirstString, LastString and Element columns of the location path table shown in FIG. 6 have been moved to a separate table (StringElementTable) that is related to the location path table on the ElementID column.

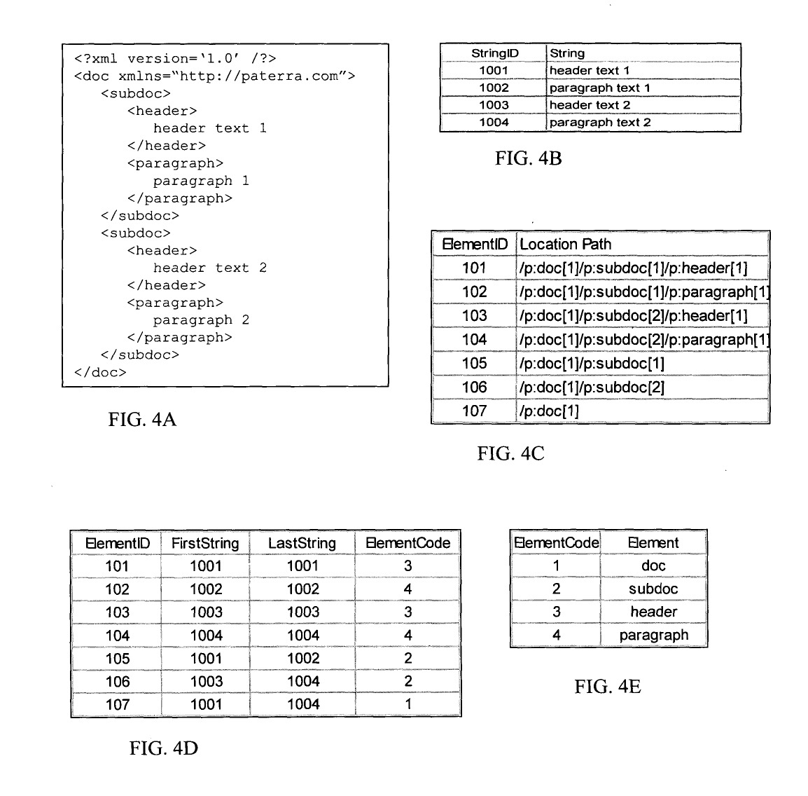

A further relational database schema according to this invention is illustrated in FIG. 4. For this schema, an Element Code Table has been constructed that contains the names of the elements to be found in the XML document together with corresponding unique codes. The Element column of the string element table shown in FIG. 5 has been replaced by an element code column that references the ElementCode column in the element code table.

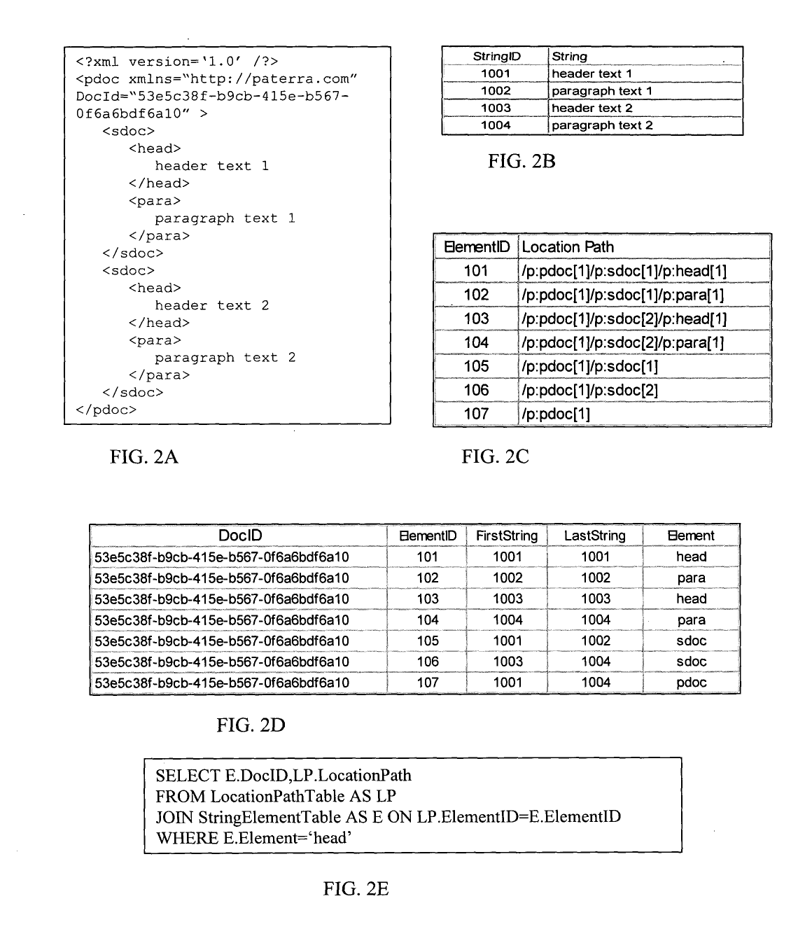

The preferred relational database schema according to this invention is illustrated in FIG. 2 and applies to the case when the XML document contains or can be assigned a unique identifier. Those skilled in the art will appreciate that any XML document can be assigned a unique identifier. The unique identifier for the document shown in FIG. 2a is a globally unique identifier. However, those skilled in the art will appreciate that there are many equivalent way of uniquely identifying XML documents that can be implemented in this or an essentially equivalent schema.

FIG. 11 illustrates a further relational database schema according to this invention. For this schema, a attribute table has been added that comprises two columns: the names of the attributes of the last element in a corresponding location path and their values. This attribute table is related to the location path table on the element id column.

According to this invention, the string table may be omitted, for example, in the case that the original document or documents are stored separately so that the unambiguous location paths in the location path table are sufficient to locate the original textual elements.

Method for Inserting Data from XML Document Into Tables

A method of this invention for inserting data from an XML document into the relational database structures of this invention is to first transform the XML document into an intermediate XML document that can then be decomposed and inserted into the database using one of the commercially available tools. In this disclosure the preferred method is to use the “updategram” feature of Microsoft Corporation's XML for SQL Server Web Release 1. Updategrams are explained in detail by Burke et al. Those skilled in the art will appreciate that essentially equivalent tools (known as “XML Database Extenders”) exist for Oracle 9i (Oracle Corporation, 2001) and IBM's DB2 (Ennser et al, 2000) and that, although the specifications for the intermediate XML document will differ depending on the database extender, the methods for these tools are essentially equivalent to those described here for Updategram insertion into Microsoft SQL Server 2000.

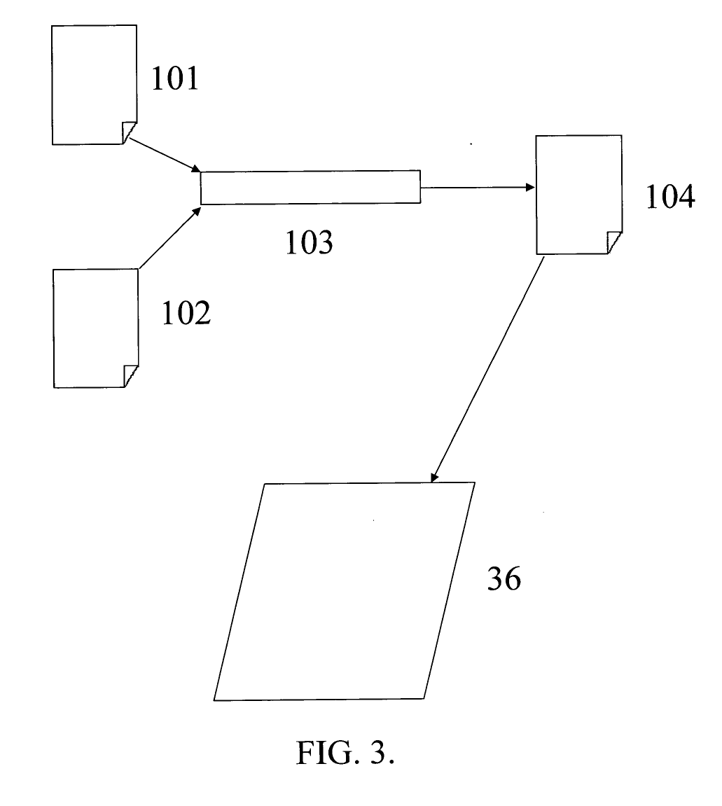

The method of this invention is shown in FIG. 3. According to this method, the starting XML document is transformed through an XSLT transformation, based on an XSL stylesheet, into an intermediate XML document that conforms to the target XML extender. XSLT transformations themselves are known to the art and are disclosed in detail in Kay, Michael (2001). XSLT: Programmer's Reference, 2^{nd} Ed., Birmingham: Wrox Press Ltd, and in Cagle, Kurt; Corning, Michael; Diamond, Jason; Duynstee, Teun; Gudmundsson, Oli Gauti; Mason, Michael; Pinnock, Jonathan; Spencer, Paul; Tang, Jeff; Watt, Andrew; Jirat, Jirka; Tchistopolskii, Paul; Tennison, Jeni (2001). Professional XSL. Birmingham: Wrox Press Ltd.

The intermediate XML document is then inserted into the relational database using the database extender provided by the vendor of the database. In the Preferred Embodiment of this disclosure, the intermediate XML Updategram produced from the XML document and the XSL stylesheet is inserted into SQL Server 2000 using the Microsoft Visual C++6.0 code listed in the Preferred Embodiment. The code uses Microsoft® SQLXML 3.0 and Microsoft XML Core Services (MSXML) 4.0. Those skilled in the art will appreciate that essentially equivalent software can be written in other languages, including but not limited to Visual Basic, Java and ECMAScript, and that this software can more or less be readily modified to meet the particular specifications of the XML extender being used.

In a simple form, the insertable Updategram produced by the XSLT transformation has the following structure:

<ROOT xmlns:updg=“urn:schemas-microsoft-com:xml-updategram >

<updg:sync>

<updg:before/>
<updg:after>

<TABLENAME COLUMN1=“VALUE1” COLUMN2=“VALUE2” ... />

</updg:after>
... repeat <updg:before/><updg:after>....</updg:after> for each row to be inserted

</updg:sync>

</ROOT>

When inserted into the relational database via the XML extender, the above updategram inserts rows of values into the table TABLENAME with VALUE 1 being entered into COLUMN 1, etc.

For the current invention, an intermediate XML updategram is generated which contains <updg:before/><updg:after>. . . </updg:after> code as shown above for each row to be entered into each table.

The values for first string and last string columns in FIG. 7 are generated with an updategram that contains identity variables for each of the strings inserted into the database and applies these identity variables to the appropriate location path rows. An identity variable is one that corresponds to an identity column in the database table into which a particular row is inserted. When this row is inserted using the database extender, the identity variable is instantiated to the identity value of the new row. This instantiated identity variable is used later, as needed, as a value in first string and last string columns.

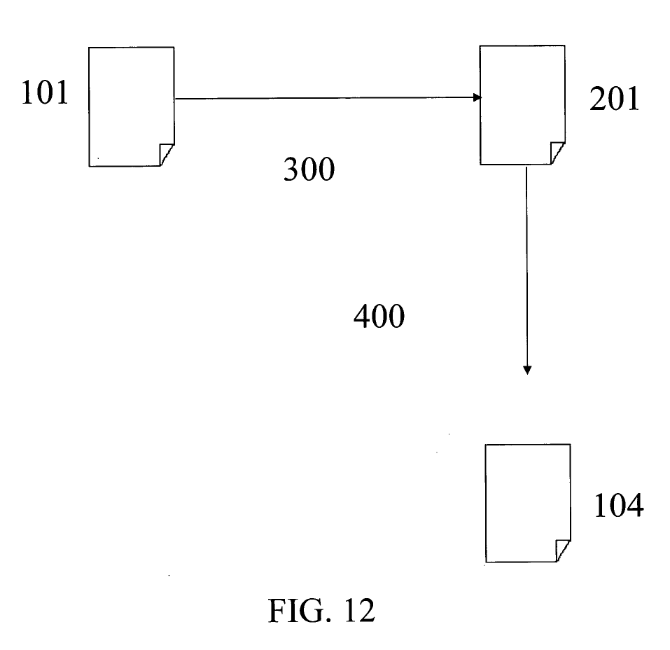

According to the method of this invention, updategram 104 is generated from XML document 101 using XSL stylesheet 102. XSL stylesheet 102 processes the XML document 101 in two steps as shown in FIG. 12. Step 300 gathers strings and path data into a temporary XML node variable 201. Step 400 transforms this temporary node 201 into the final updategram 104. Those skilled in the art will appreciate that these steps are wrapped in syntax and control code that is part of the XSLT transformation.

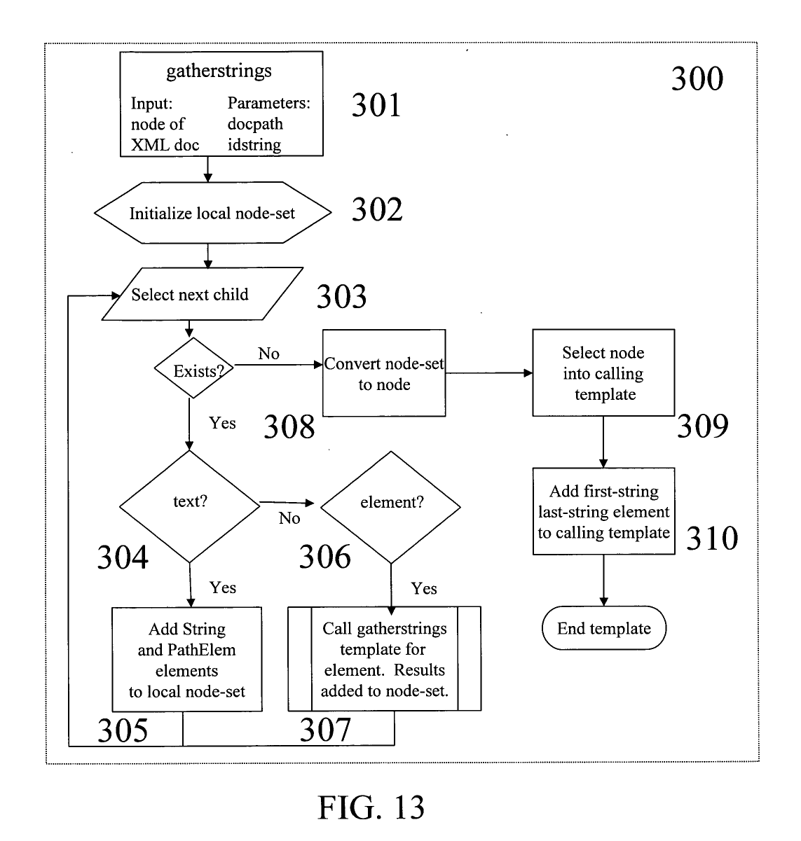

Gatherstrings template 300 is now described with reference to the flowchart in FIG. 13. Gatherstrings template 300 is used recursively with the inputs being an XML element together with two parameters “docpath” and “idstring”. The first recursion is called on the document element of XML document 101. The parameter “docpath” contains the location path of the element being processed. The parameter “idstring” is a string that will eventually serve as the name of an identity variable in final updategram 104. Idstring needs to be unique for each string to be processed in updategram 104. Those skilled in the art will appreciate that there are several ways of doing this. One way is to start with an arbitrary seed string in the first recursion, for example, “ID”, then append “−n”, where “n” is the position of the child, for each child of the element being processed. When recursing to a lower level, this appended seed string, “ID-n” is used as the seed string for the next recursion.

Recursive gatherstrings template 300 begins by initiating a local node-set 302. The template then sequentially selects each child in the element being processed (303).

If a child is a text node (304), process 305 adds a String element to the local node-set. This String element contains, as attributes, the text of the element and the idstring for that string. process 305 also adds a PathElem element to the local node-set. This PathElem element contains, as attributes, the location path of that text node, a “field” attribute that is set to the name of the element being processed, a “firststring” attribute that is set to the idstring for that string, and a “laststring” attribute that is also set to the idstring for that string.

The template then goes on to the next child.

If a child is an element (306), process 307 makes a recursive call to gatherstrings template 300. For this call, the appended idstring, for example, “ID−n”, where “n” is the position of the element, is passed as the idstring paramenter. The location path of the element is passed as the parameter “docpath.”

If there are no more children, the local node-set is converted to a node (308) and selected into the calling template (309). In addition, a PathElem element is added to the calling template at 310. This PathElem element contains, as attributes, the location path of the element being processed, a “field” attribute that is set to the name of the element being processed, a “firststring” attribute that is set to the idstring corresponding to the first String element that was added to the node-set for the element being processed, and a “laststring” attribute that is set to the idstring corresponding to the last String element that was added to the node-set for the element being processed.

Process 400 transforms the elements of gathered strings temporary XML node variable 201 into updategram 104. This transformation will vary depending on the structure of the database and several variations are exemplified in the embodiments below.

Additional data to be inserted into the database, for example, a document identifier, can be passed to gatherstrings template 201 as a parameter. This data is then added to updategram 104 as exemplified in embodiments below.

It is important that PathElem elements be added to the Gathered Strings node variable 201 after the String elements to which their “firststring” and “laststring” elements refer. This is because these idstrings are initialized by the addition of the string to the database.

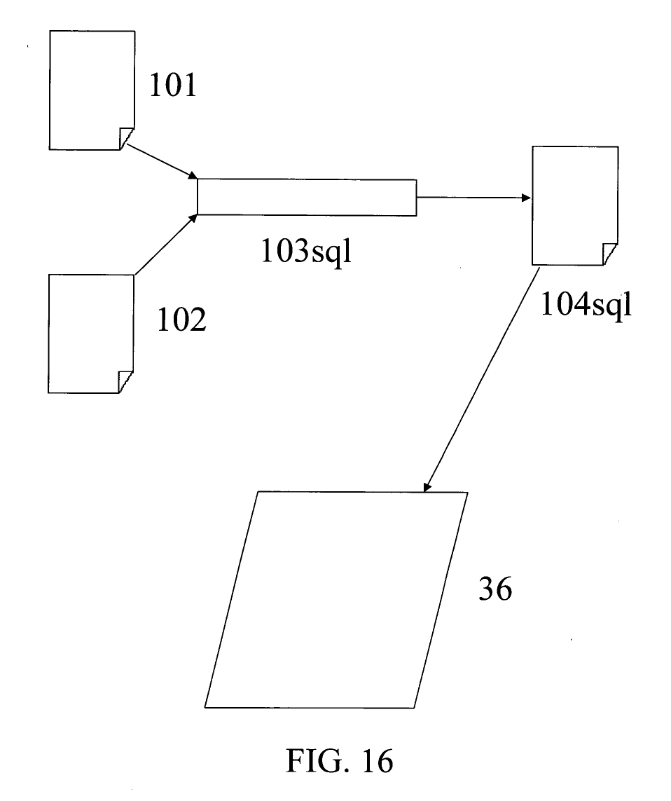

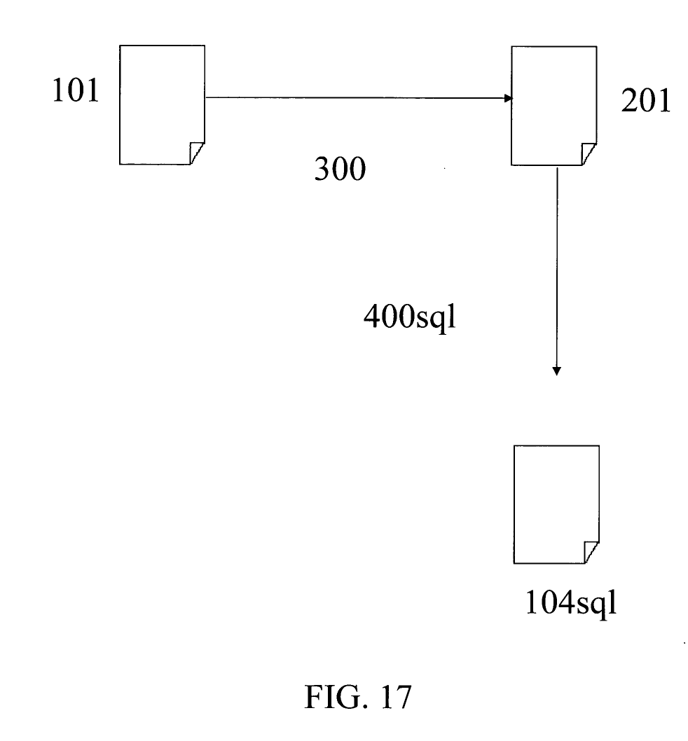

An alternative to using updategrams or similar database extenders is to produce and use an intermediate SQL script document as shown in FIGS. 16 and 17. The considerations described above for updategrams still apply except that an XLST transformation 103sql is used to produce intermediate SQL script document 104sql. Script 104sql is then applied to the relational database using procedures known to the field. This method is beneficial when the relational database management system lacks a suitable database extender.

Those skilled in the art will appreciate that many modifications can be made to the above methods without departing from the scope of the present invention.

### PREFERRED EMBODIMENT

The Preferred Embodiment of this invention will now be described with reference to FIGS. 2A-2E.

The Preferred Embodiment is installed and executed on a Dell Computer Corporation PowerEdge brand Model 6450 server computer running the Microsoft Windows 2000 Operating System and Microsoft SQL Server 2000 database software.

FIG. 2A is a generic XML document containing the minimally required top-level elements, <?xml/?> and <pdoc>. In this document, the root element <pdoc> also contains a namespace attribute and a universally unique identifier as the document identifier DocID. Also, all elements that are members of the same namespace as pdoc have tagnames of the same length, in this case four characters.

Database Tables

FIGS. 2B through 2E show the database tables and rows corresponding to the above XML document according to the teachings of this invention. In this Embodiment, these tables are created in the SQL-compliant database SQL Server 2000, a product of Microsoft Corporation.

The string table shown in FIG. 2B consists of two columns: StringID and String. This table is created in SQL Server 2000 using the following SQL script.

create table StringTable
(

StringID bigint identity(1,1) not null primary key,
String nvarchar(4000) not null

)

StringID is an identity column as described in Vieira, Robert (2000), Professional SQL Server 2000 Programming. Birmingham : Wrox Press Ltd., p.155 (hereinafter, “Viera”). This means that it is a unique, sequenced number automatically generated by SQL Server 2000 when a String is inserted into StringTable. String is a variable length column that holds up to 4000 Unicode characters and contains text( ) elements from the XML document in FIG. 2A.

The location path table shown in FIG. 2C consists of two columns ElementID and LocationPath. This table is created in SQL Server 2000 using the following SQL script.

create table LocationPathTable
(

ElementID bigint identity(1,1) not null primary key,
LocationPath varchar(256)

)

ElementID is an identity column. LocationPath is a variable length column that contains absolute location paths from the XML document in FIG. 2A.

The string element table shown in FIG. 2D consists of five columns DocID, ElementID, FirstString, LastString, and ElementCode. This table is created in SQL Server 2000 using the following SQL script.

create table StringElementTable
(

DocID uniqueidentifier not null,
ElementID bigint not null foreign key references
LocationPathTable(ElementID)primary key,
FirstString bigint not null,
LastString bigint not null,
Element char(4) not null

)

DocID is the value of the attribute DocID of element pdoc in the XML document. StringElementTable is related to LocationPath Table on the ElementID column. FirstString is the StringID of the first text( ) element in the XML document that is a descendant of the LocationPath corresponding to ElementID and

LastString is the last text( ) element that is a descendant of that LocationPath. Element is the name of the last element in this LocationPath.

Method for Inserting Data in Tables Based on an XML Document

In this Preferred Embodiment, data is inserted into the above tables from an XML document using an Updategram that is generated using an XSL stylesheet. This method is shown in FIG. 3. The XSL stylesheet below is used to generate an Updategram that is then used to insert the textual strings of the XML document into SQL Server 2000 as taught in Burke et al.

<?xml version=“1.0” encoding=“UTF-16” standalone=“yes”?>
<xsl:stylesheet version=“1.0” xmlns:xsl=“http://www.w3.org/1999/XSL/Transform”

xmlns:msxml=“urn:schemas-microsoft-com:xslt”
xmlns:updg=“urn:schemas-microsoft-com:xml-updategram”
xmlns:p=“urn:schemas-paterra-com”
xmlns:dt=“urn:schemas-microsoft-com:datatypes”
xmlns:pi=“urn:schemas-pi-paterra-com”
>

<xsl:template match=“/”>

<ROOT>

<updg:sync>

<xsl:call-template name=“top” >

<xsl:with-param name=“DocID” select=“$docid” />

</xsl:call-template>

</updg:sync>

</ROOT>

</xsl:template>
<xsl:template name=“top” >

<xsl:param name=“DocID” />
<!-- gather strings and names of string ids from tree -->
<xsl:variable name=“gathered.strings.tf” >

<xsl:call-template name=“gatherstrings”/>

</xsl:variable>
<xsl:variable name=“gathered.strings” select=“msxml:node-set($gathered.strings.tf)” />
<!-- output updategram -->
<xsl:for-each select=“$gathered.strings/*” >

<xsl:choose>

<xsl:when test=“ name( ) = ‘pi:String’ ” >

<updg:before />
<updg:after >

<StringTable>

<xsl:attribute name=“updg:at-identity” ><xsl:value-of select=“@idname” /></xsl:attribute>
<xsl:attribute name=“String” ><xsl:value-of select=“@content” /></xsl:attribute>

</StringTable>

</updg:after>

</xsl:when>
<xsl:when test=“ name( ) = ‘pi:PathElem’ ” >

<updg:before />
<updg:after >

<LocationPathTable>

<xsl:attribute name=“updg:at-identity” >elementidentity</xsl:attribute>
<xsl:attribute name=“LocationPath” ><xsl:value-of select=“@path” /></xsl:attribute>

</LocationPathTable>

</updg:after>
<updg:before />
<updg:after >

<StringElementTable >

<xsl:attribute name=“ElementID” >elementidentity</xsl:attribute>
<xsl:attribute name=“DocID” ><xsl:value-of select=“$DocID” /></xsl:attribute>
<xsl:attribute name=“FirstString”><xsl:value-of select=“@firststringid” /></xsl:attribute>
<xsl:attribute name=“LastString”><xsl:value-of select=“@laststringid” /></xsl:attribute>
<xsl:attribute name=“Element” ><xsl:value-of select=“@field” /></xsl:attribute>

</StringElementTable>

</updg:after>

</xsl:when>

</xsl:choose>

</xsl:for-each>

</xsl:template>
<!-- the code below is common for the Preferred Embodiment and Alternate Embodiments 1 through 4, and
Alternate Embodiment 12 -->
<xsl:template name=“gatherstrings” >

<xsl:param name=“idname” select=“‘id’” />
<xsl:param name=“docpath” select=“dummy” />
<!-- gather strings and names of string ids from tree -->
<xsl:variable name=“gathered.nodes.tf” >

<xsl:for-each select=“child::*” >

<xsl:variable name=“thisPosition” select=“count(preceding-sibling::*[name(current( )) = name( )])”

/>

<xsl:choose>

<xsl:when test=“current( ) = text( )” >

<xsl:variable name=“textidstr” select=“concat( $idname, ‘_’, position( ))” />
<pi:String>

<xsl:attribute name=“idname”>

<xsl:value-of select=“$textidstr” />

</xsl:attribute>
<xsl:attribute name=“content” >

<xsl:value-of select=“.” />

</xsl:attribute>
<xsl:attribute name=“path” >

<xsl:value-of select=“concat($docpath,‘/p:’,name( ),‘[’,$thisPosition+1,‘]’)” />

</xsl:attribute>

</pi:String>
<pi:PathElem>

<xsl:attribute name=“field” >

<xsl:value-of select=“name( )” />

</xsl:attribute>
<xsl:attribute name=“firststringid”>
<xsl:value-of select=“concat( $idname, ‘_’, position( ))” />
</xsl:attribute>
<xsl:attribute name=“laststringid”>
<xsl:value-of select=“concat( $idname, ‘_’, position( ))” />
</xsl:attribute>
<xsl:attribute name=“path” >

<xsl:value-of select=“concat($docpath,‘/p:’,name( ),‘[’,$thisPosition+1,‘]’)” />

</xsl:attribute>

</pi:PathElem>

</xsl:when>
<xsl:otherwise>

<xsl:call-template name=“gatherstrings”>

<xsl:with-param name=“idname” ><xsl:value-of select=“concat( $idname, ‘_’, position( ))”

/></xsl:with-param>

<xsl:with-param name=“docpath” ><xsl:value-of

select=“concat($docpath,‘/p:’,name( ),‘[’,$thisPosition+1,‘]’)” /></xsl:with-param>

</xsl:call-template>

</xsl:otherwise>

</xsl:choose>

</xsl:for-each>

</xsl:variable>
<xsl:variable name=“gathered.nodes” select=“msxml:node-set($gathered.nodes.tf)” />
<!-- output updategram -->
<xsl:for-each select=“$gathered.nodes/*” >

<xsl:copy-of select=“.” />

</xsl:for-each>
<xsl:if test=“ name( ) != ” ” >

<xsl:if test=“$gathered.nodes/pi:String[1]/@idname != ” ” >

<pi:PathElem>

<xsl:attribute name=“field” >

<xsl:value-of select=“name( )” />

</xsl:attribute>
<xsl:attribute name=“firststringid”>

<xsl:value-of select=“$gathered.nodes/pi:String[1]/@idname” />

</xsl:attribute>
<xsl:attribute name=“laststringid”>

<xsl:value-of select=“$gathered.nodes/pi:String[last( )]/@idname” />

</xsl:attribute>
<xsl:attribute name=“path” >

<xsl: value-of select=“$docpath” />

</xsl:attribute>

</pi:PathElem>

</xsl:if>

</xsl:if>

</xsl:template>
</xsl:stylesheet>
In the Preferred Embodiment, the Updategram produced from the XML document and the above XSL
stylesheet is inserted into SQL Server 2000 using the following Microsoft Visual C++ 6.0 code. Error
handling and other utility routines have been omitted as these are known to those knowledgeable in the
field. The following code uses Microsoft ® SQLXML 3.0 and Microsoft XML Core Services (MSXML)
4.0.

wstring wsXMLFileName = (supplied by user);
wstring wsStyle = (supplied by user);
// load xml file and XML−>DBMT stylesheet
CComPtr< IXMLDOMDocument > spXML;
HRESULT hr = spXML.CoCreateInstance( L“Msxml2.DOMDocument.4.0” );
VARIANT_BOOL bLoaded;
hr = spXML−>put_async( VARIANT_FALSE);
_variant_t varFile(wsXMLFileName.c_str( ));
hr = spXML−>load(varFile , &bLoaded );
CComPtr< IXMLDOMDocument > spStyle;
hr = spStyle.CoCreateInstance( L“Msxml2.DOMDocument.4.0” );
hr = spStyle−>put_async( VARIANT_FALSE);
hr = spStyle−>load( CComVariant( wsStyle.c_str( )), &bLoaded );
CCom Variant vObject;
CComPtr< IXMLDOMDocument > spUpdategram;
hr = spUpdategram.CoCreateInstance( L“Msxml2.DOMDocument.4.0” );
vObject.vt = VT_DISPATCH; // the new object
hr = spUpdategram.CopyTo((IXMLDOMDocument**)&vObject.pdispVal );
hr = spXML−>transformNodeToObject( spStyle, vObject );
// now create the ADO connection and send the updategram
_variant_t vtEmpty(DISP_E_PARAMNOTFOUND,VT_ERROR);
_variant_t vtra(DISP_E_PARAMNOTFOUND,VT_ERROR);
_CommandPtr pCmd = NULL;
_ConnectionPtr pConnection = NULL;
_StreamPtr pStreamIn = NULL;
_StreamPtr pStreamOut = NULL;
hr = pCmd.CreateInstance(_uuidof(Command));
hr = pConnection.CreateInstance(_uuidof(Connection));
pConnection−>CursorLocation = adUseClient;
CComBSTR bstrConnectionString;bstrConnectionString.Empty( );

bstrConnectionString.Append( L“provider=SQLXMLOLEDB.2.0;data \ provider=SQLOLEDB;data
source=SERVER; initial catalog=DATABASE;”);

hr = pConnection−>Open( bstrConnectionString.m_str, _bstr_t(L“USER”), _bstr_t(L“PASSWORD” \

),adConnectUnspecified );

pCmd−>ActiveConnection = pConnection;
hr = pStreamIn.CreateInstance(_uuidof(Stream));
hr = pStreamOut.CreateInstance(_uuidof(Stream));
_variant_t vtEmpty(DISP_E_PARAMNOTFOUND,VT_ERROR);
hr = pStreamIn−>Open( vtEmpty , adModeUnknown, adOpenStreamUnspecified , L””, L”” );
hr = pStreamOut−>Open( vtEmpty , adModeUnknown, adOpenStreamUnspecified , L””, L”” );
CComBSTR bstrUPDG;
spUpdategram−>get_xml( &bstrUPDG );
hr = pStreamIn−>WriteText(_bstr_t( bstrUPDG.Detach( )) , adWriteChar );
hr = pStreamIn−>put_Position(0);
hr = pCmd−>putref_CommandStream( pStreamIn );
hr = pCmd−>put_Dialect(_bstr_t(L“{5d531cb2-e6ed-11d2-b252-00c04f681b71}”));
hr = pCmd−>Properties−>Item[L“Output Stream”]−>put_Value(_variant_t((IDispatch*) pStreamOut));
hr = pCmd−>Properties−>Item[L“Output Encoding”]−>put_Value(_variant_t(L“UTF-16”));
hr = pCmd−>Execute(&vtra,&vtEmpty,adExecuteStream);
pStreamOut−>Position = 0;
// get the ptrans jobid from the returned xml and insert it into PMT.dbo.tblPMT2Jobs
CComPtr< IXMLDOMDocument > spReturn;
hr = spReturn.CoCreateInstance( L“Msxml2.DOMDocument.4.0” );
long nReturnLength = pStreamOut−>Size;
hr = spReturn−>put_async( VARIANT_FALSE);
hr = spReturn−>loadXML( pStreamOut−>ReadText( nReturnLength) , &bLoaded );
pStreamOut−>Position = 0;
hr = pStreamIn−>Close( );
hr = pStreamOut−>Close( );
hr = pConnection−>Close( );
spXML.Release( );
spUpdategram.Release( );
spReturn.Release( );

Database Connection and Search Query

A database connection is established using the OSQL client utility supplied with Microsoft SQL Server 2000. Entering the query shown in FIG. 2E retrieves the DocIDs and LocationPaths of elements named ‘head’.

### Alternate Embodiment 1

Alternate Embodiment 1 of this invention will now be described with reference to FIGS. 4A-4E. FIG. 4A is a generic XML document containing the minimally required top-level elements, <?xml/?> and <doc>. In this document, the root element <doc> also contains a namespace attribute.

Database Tables

FIGS. 4B through 4E show the database tables and rows corresponding to the above XML document according to the teachings of this invention. In this Embodiment, these tables are created in the SQL-compliant database SQL Server 2000, a product of Microsoft Corporation.

StringTable (FIG. 4B) and LocationPathTable (FIG. 4C) are constructed as for those in the Preferred Embodiment. The string element table is replaced by the string element table shown in FIG. 4D and consists of four columns ElementID, FirstString, LastString, and ElementCode. This table is created in SQL Server 2000 using the following SQL script.

create table StringElementTable
(

ElementID bigint not null foreign key references
LocationPathTable(ElementID)primary key,
FirstString bigint not null,
LastString bigint not null,
ElementCode int not null foreign key references
ElementCodeTable(ElementCode)

)

StringElementTable is related to LocationPathTable on the ElementID column and to ElementCodeTable on the ElementCode column. FirstString is the StringID of the first text( ) element in the XML document that is a descendant of the LocationPath corresponding to ElementID and LastString is the last text( ) element that is a descendant of that LocationPath. ElementCode the member of ElementCode in ElementCodeTable corresponding to the name of the last element in this LocationPath.

This Alternate Embodiment 1 also includes the element code table shown in FIG. 4E that consists of two columns ElementCode and Element. This table is created in SQL Server using the following SQL script.

create table ElementCode Table
(

ElementCode int identity not null primary key,
Element varchar(32)

)

Method for Inserting Data in Tables Based on an XML Document

In this Alternate Embodiment 1, data is inserted into the above tables from an XML document using an Updategram that is generated using an XSL stylesheet. This method is shown in FIG. 3. The XSL stylesheet below is used to generate an Updategram that is then used to insert the textual strings of the XML document into SQL Server 2000 as taught in Burke et al (2001).

<?xml version=“1.0” encoding=“UTF-16” standalone=“yes”?>
<xsl:stylesheet version=“1.0” xmlns:xsl=“http://www.w3.org/1999/XSL/Transform”

xmlns:msxml=“urn:schemas-microsoft-com:xslt”
xmlns:updg=“urn:schemas-microsoft-com:xml-updategram”
xmlns:p=“urn:schemas-paterra-com”
xmlns:dt=“urn:schemas-microsoft-com:datatypes”
xmlns:pi=“urn:schemas-pi-paterra-com”
>

<xsl:template match=“/”>

<ROOT>

<updg:sync>

<xsl:call-template name=“top” />

</updg:sync>

</ROOT>

</xsl:template>
<xsl:template name=“top” >

<!-- gather strings and names of string ids from tree -->
<xsl:variable name=“gathered.strings.tf” >

<xsl:call-template name=“gatherstrings”/>

</xsl:variable>
<xsl:variable name=“gathered.strings” select=“msxml:node-set($gathered.strings.tf)” />
<!-- output updategram -->
<xsl:for-each select=“$gathered.strings/*” >

<xsl:choose>

<xsl:when test=“ name( ) = ‘pi:String’ ” >

<updg:before />
<updg: after >

<StringTable>

<xsl:attribute name=“updg:at-identity” ><xsl:value-of select=“@idname” /></xsl:attribute>
<xsl:attribute name=“String” ><xsl:value-of select=“@content” /></xsl:attribute>

</StringTable>

</updg:after>

</xsl:when>
<xsl:when test=“ name( ) = ‘pi:PathElem’ ” >

<updg:before />
<updg: after >

<LocationPathTable>

<xsl:attribute name=“updg:at-identity” >elementidentity</xsl:attribute>
<xsl:attribute name=“LocationPath” ><xsl:value-of select=“@path” /></xsl:attribute>

</LocationPathTable>

</updg:after>
<updg:before>

<ElementCodeTable updg:id=“elemid” >

<xsl:attribute name=“Element” ><xsl:value-of select=“@field” /></xsl:attribute>

</ElementCodeTable>

</updg:before>
<updg:after>

<ElementCodeTable updg:id=“elemid” >

<xsl:attribute name=“Element” ><xsl:value-of select=“@field” /></xsl:attribute>

</ElementCodeTable>

</updg:after>
<updg:before />
<updg: after >

<StringElementTable >

<xsl:attribute name=“ElementID” >elementidentity</xsl:attribute>
<xsl:attribute name=“FirstString”><xsl:value-of select=“@firststringid” /></xsl:attribute>
<xsl:attribute name=“LastString”><xsl:value-of select=“@laststringid” /></xsl:attribute>
<xsl:attribute name=“ElementCode” >elemid</xsl:attribute>

</StringElementTable>

</updg:after>

</xsl:when>

</xsl:choose>

</xsl:for-each>

</xsl:template>
<!-- The code below is the same as for the Preferred Embodiment and is here omitted for brevity. -->

The Updategram generated by transforming the XML document with the above XSL stylesheet is then inserted into the SQL Server 2000 database using the algorithm of the Preferred Embodiment.

### Alternate Embodiment 2

Alternate Embodiment 2 of this invention will now be described with reference to FIGS. 5A-5D. FIG. 5A is a generic XML document containing the minimally required top-level elements, <?xml/?> and <doc>. In this document, the root element <doc> also contains a namespace attribute.

Database Tables

FIGS. 5B through 5D show the database tables and rows corresponding to the above XML document according to the teachings of this invention. In this Embodiment, these tables are created in the SQL-compliant database SQL Server 2000, a product of Microsoft Corporation.

StringTable (FIG. 5B) and LocationPathTable (FIG. 5C) are constructed as for those in the Preferred Embodiment. The string element table is replaced by the string element table shown in FIG. 5D and consists of four columns ElementID, FirstString, LastString, and ElementCode. This table is created in SQL Server 2000 using the following SQL script.

create table StringElementTable
(

ElementID bigint not null foreign key references
LocationPathTable(ElementID)primary key
FirstString bigint not null,
LastString bigint not null,
Element char(10) not null

)

StringElementTable is related to LocationPathTable on the ElementID column and to ElementCodeTable on the ElementCode column. FirstString is the StringID of the first text( ) element in the XML document that is a descendant of the LocationPath corresponding to ElementID and LastString is the last text( ) element that is a descendant of that LocationPath.

Method for Inserting Data in Tables Based on an XML Document

In this Alternate Embodiment 2, data is inserted into the above tables from an XML document using an Updategram that is generated using an XSL stylesheet. This method is shown in FIG. 3. The XSL stylesheet below is used to generate an Updategram that is then used to insert the textual strings of the XML document into SQL Server 2000 as taught in Burke et al.

<?xml version=“1.0” encoding=“UTF-16” standalone=“yes”?>
<xsl:stylesheet version=“1.0” xmlns:xsl=“http://www.w3.org/1999/XSL/Transform”

xmlns:msxml=“urn:schemas-microsoft-com:xslt”
xmlns:updg=“urn:schemas-microsoft-com:xml-updategram”
xmlns:p=“urn:schemas-paterra-com”
xmlns:dt=“urn:schemas-microsoft-com:datatypes”
xmlns:pi=“urn:schemas-pi-paterra-com”
>

<xsl:template match=“/”>

<ROOT>

<updg:sync>

<xsl:call-template name=“top” />
</updg:sync>

</ROOT>

</xsl:template>
<xsl:template name=“top” >

<!-- gather strings and names of string ids from tree -->
<xsl:variable name=“gathered.strings.tf” >

<xsl:call-template name=“gatherstrings”/>

</xsl:variable>
<xsl:variable name=“gathered.strings” select=“msxml:node-set($gathered.strings.tf)” />
<!-- output updategram -->
<xsl:for-each select=“$gathered.strings/*” >

<xsl:choose>

<xsl:when test=“ name( ) = ‘pi:String’ ” >

<updg:before />
<updg: after >

<StringTable>

<xsl:attribute name=“updg:at-identity” ><xsl:value-of select=“@idname” /></xsl:attribute>
<xsl:attribute name=“String” ><xsl:value-of select=“@content” /></xsl:attribute>

</StringTable>

</updg:after>

</xsl:when>
<xsl:when test=“ name( ) = ‘pi:PathElem’ ” >

<updg:before />
<updg:after >

<LocationPathTable>

<xsl:attribute name=“updg:at-identity” >elementidentity</xsl:attribute>
<xsl:attribute name=“LocationPath” ><xsl:value-of select=“@path” /></xsl:attribute>

</LocationPathTable>

</updg:after>
<updg:before />
<updg:after >

<StringElementTable >

<xsl:attribute name=“ElementID” >elementidentity</xsl:attribute>
<xsl:attribute name=“FirstString”><xsl:value-of select=“@firststringid” /></xsl:attribute>
<xsl:attribute name=“LastString”><xsl:value-of select=“@laststringid” /></xsl:attribute>
<xsl:attribute name=“Element” ><xsl:value-of select=“@field” /></xsl:attribute

</StringElementTable>

</updg:after>

</xsl:when>

</xsl:choose>

</xsl:for-each>

</xsl:template>
<!-- The code below is the same as for the Preferred Embodiment and is here omitted for brevity. -->

The Updategram generated by transforming the XML document with the above XSL stylesheet is then inserted into the SQL Server 2000 database using the algorithm of the Preferred Embodiment.

### Alternate Embodiment 3

Alternate Embodiment 3 of this invention will now be described with reference to FIGS. 6A-6C. FIG. 6A is a generic XML document containing the minimally required top-level elements, <?xml/?> and <doc>. In this document, the root element <doc> also contains a namespace attribute.

Database Tables

FIGS. 6B and 6C show the database tables and rows corresponding to the above XML document according to the teachings of this invention. In this Embodiment, these tables are created in the SQL-compliant database SQL Server 2000, a product of Microsoft Corporation.

StringTable (FIG. 6B) is constructed as for those in the Alternate Embodiment 2. The string element table and location path table are replaced by the location path table shown in FIG. 6C that consists of five columns ElementID, FirstString, LastString, ElementCode and LocationPath. This table is created in SQL Server 2000 using the following SQL script.

```
create table LocationPathTable
(
  ElementID bigint identity(1,1) not null primary key,
  FirstString bigint not null,
  LastString bigint not null,
  Element char(10) not null,
  LocationPath varchar(256)
)
```

FirstString is the StringID of the first text( ) element in the XML document that is a descendant of the LocationPath corresponding to ElementID and LastString is the last text( ) element that is a descendant of that LocationPath.

Method for Inserting Data in Tables Based on an XML Document

In this Alternate Embodiment 3, data is inserted into the above tables from an XML document using an Updategram that is generated using an XSL stylesheet. This method is shown in FIG. 3. The XSL stylesheet below is used to generate an Updategram that is then used to insert the textual strings of the XML document into SQL Server 2000 as taught in Burke et al (2001).

```
<?xml version=“1.0” encoding=“UTF-16” standalone=“yes”?>
<xsl:stylesheet version=“1.0” xmlns:xsl=“http://www.w3.org/1999/XSL/Transform”
  xmlns:msxml=“urn:schemas-microsoft-com:xslt”
  xmlns:updg=“urn:schemas-microsoft-com:xml-updategram”
  xmlns:p=“urn:schemas-paterra-com”
  xmlns:dt=“urn:schemas-microsoft-com:datatypes”
  xmlns:pi=“urn:schemas-pi-paterra-com”
  >
<xsl:template match=“/”>
  <ROOT>
      <updg:sync>
      <xsl:call-template name=“top” />
      </updg:sync>
  </ROOT>
</xsl:template>
<xsl:template name=“top”>
  <!-- gather strings and names of string ids from tree -->
  <xsl:variable name=“gathered.strings.tf” >
    <xsl:call-template name=“gatherstrings”/>
  </xsl:variable>
  <xsl:variable name=“gathered.strings” select=“msxml:node-set($gathered.strings.tf)” />
  <!-- output updategram -->
  <xsl:for-each select=“$gathered.strings/*” >
    <xsl:choose>
      <xsl:when test=“ name( ) = ‘pi:String’ ” >
        <updg:before />
        <updg:after>
          <StringTable>
            <xsl:attribute name=“updg:at-identity” ><xsl:value-of select=“@idname” /></xsl:attribute>
            <xsl:attribute name=“String” ><xsl:value-of select=“@content” /></xsl:attribute>
          </StringTable>
        </updg:after>
      </xsl:when>
      <xsl:when test=“ name( ) = ‘pi:PathElem’ ” >
        <updg:before />
        <updg:after >
          <LocationPathTable>
            <xsl:attribute name=“updg:at-identity” >elementidentity</xsl:attribute>
            <xsl:attribute name=“FirstString”><xsl:value-of select=“@firststringid” /></xsl:attribute>
            <xsl:attribute name=“LastString”><xsl:value-of select=“@laststringid” /></xsl:attribute>
            <xsl:attribute name=“Element” ><xsl:value-of select=“@field” /></xsl:attribute>
            <xsl:attribute name=“LocationPath” ><xsl:value-of select=“@path” /></xsl:attribute>
          </ LocationPathTable >
        </updg:after>
      </xsl:when>
    </xsl:choose>
  </xsl:for-each>
</xsl:template>
<!-- The code below is the same as for the Preferred Embodiment and is here omitted for brevity. -->
```

The Updategram generated by transforming the XML document with the above XSL stylesheet is then inserted into the SQL Server 2000 database using the algorithm of the Preferred Embodiment.

### Alternate Embodiment 4

Alternate Embodiment 4 of this invention will now be described with reference to FIGS. 7A-7C. FIG. 7A is a generic XML document containing the minimally required top-level elements, <?xml/?> and <doc>. In this document, the root element <doc> also contains a namespace attribute.

Database Tables

FIGS. 7B and 7C show the database tables and rows corresponding to the above XML document according to the teachings of this invention. In this Embodiment, these tables are created in the SQL-compliant database SQL Server 2000, a product of Microsoft Corporation.

StringTable (FIG. 7B) is constructed as for those in the Alternate Embodiment 2. The string element table and location path table are replaced by the location path table shown in FIG. 7C that consists of four columns ElementID, FirstString, LastString, and LocationPath. This table is created in SQL Server 2000 using the following SQL script.

```
create table LocationPathTable
(
  ElementID bigint identity(1,1) not null primary key,
  FirstString bigint not null,
  LastString bigint not null,
  LocationPath varchar(256)
)
```

FirstString is the StringID of the first text( ) element in the XML document that is a descendant of the LocationPath corresponding to ElementID and LastString is the last text( ) element that is a descendant of that LocationPath.

Method for Inserting Data in Tables Based on an XML Document

In this Alternate Embodiment 4, data is inserted into the above tables from an XML document using an Updategram that is generated using an XSL stylesheet. This method is shown in FIG. 3. The XSL stylesheet below is used to generate an Updategram (shown in FIG. 7D) that is then used to insert the textual strings of the XML document into SQL Server 2000 as taught in Burke et al.

```
<?xml version=“1.0” encoding=“UTF-16” standalone=“yes”?>
<xsl:stylesheet version=“1.0” xmlns:xsl=“http://www.w3.org/1999/XSL/Transform”
  xmlns:msxml=“urn:schemas-microsoft-com:xslt”
  xmlns:updg=“urn:schemas-microsoft-com:xml-updategram”
  xmlns:p=“urn:schemas-paterra-com”
  xmlns:dt=“urn:schemas-microsoft-com:datatypes”
  xmlns:pi=“urn:schemas-pi-paterra-com”
  >
<xsl:template match=“/”>
  <ROOT>
    <updg:sync>
      <xsl:call-template name=“top” />
      </updg:sync>
  </ROOT>
</xsl:template>
<xsl:template name=“top” >
  <!-- gather strings and names of string ids from tree -->
  <xsl:variable name=“gathered.strings.tf” >
    <xsl:call-template name=“gatherstrings”/>
  </xsl:variable>
  <xsl:variable name=“gathered.strings” select=“msxml:node-set($gathered.strings.tf)” />
  <!-- output updategram -->
  <xsl:for-each select=“$gathered.strings/*” >
    <xsl:choose>
      <xsl:when test=“ name( ) = ‘pi:String’ ” >
        <updg:before />
        <updg:after >
          <StringTable>
            <xsl:attribute name=“updg:at-identity” ><xsl:value-of select=“@idname” /></xsl:attribute>
            <xsl:attribute name=“String” ><xsl:value-of select=“@content” /></xsl:attribute>
          </StringTable>
        </updg:after >
      </xsl:when>
      <xsl:when test=“name( ) = ‘pi:PathElem’ ” >
        <updg:before />
        <updg:after>
          <LocationPathTable>
            <xsl:attribute name=“updg:at-identity” >elementidentity</xsl:attribute>
            <xsl:attribute name=“FirstString”><xsl:value-of select=“@firststringid” /></xsl:attribute>
            <xsl:attribute name=“LastString”><xsl:value-of select=“@laststringid” /></xsl:attribute>
            <xsl:attribute name=“LocationPath” ><xsl:value-of select=“@path” /></xsl:attribute>
          </ LocationPathTable>
        </updg:after>
      </xsl:when>
    </xsl:choose>
  </xsl:for-each>
</xsl:template>
<!-- The code below is the same as for the Preferred Embodiment and is here omitted for brevity. -->
```

The Updategram generated by transforming the XML document with the above XSL stylesheet is then inserted into the SQL Server 2000 database using the algorithm of the Preferred Embodiment.

### Alternate Embodiment 5

Alternate Embodiment 5 of this invention will now be described with reference to FIGS. 8A-8C. FIG. 8A is a generic XML document containing the minimally required top-level elements, <?xml/?> and <doc>. In this document, the root element <doc> also contains a namespace attribute.

Database Tables

FIGS. 8B and 8C show the database tables and rows corresponding to the above XML document according to the teachings of this invention. In this Embodiment, these tables are created in the SQL-compliant database SQL Server 2000, a product of Microsoft Corporation.

StringTable (FIG. 8B) is constructed as for those in the Alternate Embodiment 2. The location path table is replaced by the location path table shown in FIG. 8C that consists of two columns StringID and LocationPath. This table is created in SQL Server 2000 using the following SQL script.

```
create table LocationPathTable
(
  StringID bigint not null foreign key references String
  Table(StringID) primary key,
  LocationPath varchar(256)
)
```

LocationPath is the absolute location path of the string in StringTable corresponding to StringID.

Method for Inserting Data in Tables Based on an XML Document

In this Alternate Embodiment 5, data is inserted into the above tables from an XML document using an Updategram that is generated using an XSL stylesheet. This method is shown in FIG. 3. The XSL stylesheet below is used to generate an Updategram that is then used to insert the textual strings of the XML document into SQL Server 2000 as taught in Burke et al.

```
<?xml version=“1.0” encoding=“UTF-16” standalone=“yes”?>
<xsl:stylesheet version=“1.0” xmlns:xsl=“http://www.w3.org/1999/XSL/Transform”
  xmlns:msxml=“urn:schemas-microsoft-com:xslt”
  xmlns:updg=“urn:schemas-microsoft-com:xml-updategram”
  xmlns:p=“urn:schemas-paterra-com”
  xmlns:dt=“urn:schemas-microsoft-com:datatypes”
  xmlns:pi=“urn:schemas-pi-paterra-com”
  >
<xsl:template match=“/”>
  <ROOT>
      <updg:sync>
      <xsl:call-template name=“top” />
      </updg:sync>
  </ROOT>
</xsl:template>
<xsl:template name=“top” >
  <!-- gather strings and names of string ids from tree -->
  <xsl:variable name=“gathered.strings.tf” >
    <xsl:call-template name=“gatherstrings”/>
  </xsl:variable>
  <xsl:variable name=“gathered.strings” select=“msxml:node-set($gathered.strings.tf)” />
  <!-- output updategram -->
  <xsl:for-each select=“$gathered.strings/*” >
    <xsl:choose>
      <xsl:when test=“ name( ) = ‘pi:String’ ” >
        <updg:before />
        <updg:after >
          <StringTable>
            <xsl:attribute name=“updg:at-identity” >stringidentity</xsl:attribute>
            <xsl:attribute name=“String” ><xsl:value-of select=“@content” /></xsl:attribute>
          </StringTable>
        </updg:after>
        <updg:before />
        <updg:after >
          <LocationPathTable>
            <xsl:attribute name=“StringID” >stringidentity </xsl:attribute>
            <xsl:attribute name=“LocationPath” ><xsl:value-of select=“@path” /></xsl:attribute>
          </ LocationPathTable >
        </updg:after>
      </xsl:when>
    </xsl:choose>
  </xsl:for-each>
</xsl:template>
<xsl:template name=“gatherstrings” >
  <xsl:param name=“idname” select=“‘id’” />
  <xsl:param name=“docpath” select=“dummy” />
  <!-- gather strings and names of string ids from tree -->
  <xsl:variable name=“gathered.nodes.tf” >
      <xsl:for-each select=“child::*” >
        <xsl:variable name=“thisPosition” select=“count(preceding-sibling::*[name(current( )) = name( )])”
/>
        <xsl:choose>
          <xsl:when test=“current( ) = text( )” >
            <xsl:variable name=“textidstr” select=“concat( $idname,‘_’, position( ) )” />
            <pi:String>
              <xsl:attribute name=“idname”>
                <xsl:value-of select=“$textidstr” />
              </xsl:attribute>
              <xsl:attribute name=“content” >
                <xsl:value-of select=“.” />
              </xsl:attribute>
              <xsl:attribute name=“path” >
                <xsl:value-of select=“concat($docpath,‘/p:’,name( ),‘[‘,$thisPosition+1,’]’)” />
              </xsl:attribute>
            </pi:String>
          </xsl:when>
          <xsl:otherwise>
              <xsl:call-template name=“gatherstrings”>
                <xsl:with-param name=“idname” ><xsl:value-of select=“concat( $idname, ‘_’, position( ) )”
/></xsl:with-param>
                <xsl:with-param name=“docpath” ><xsl:value-of
select=“concat($docpath,‘/p:’,name( ),‘[‘,$thisPosition+1,’]’)” /></xsl:with-param>
              </xsl:call-template>
          </xsl:otherwise>
        </xsl:choose>
      </xsl:for-each>
  </xsl:variable>
  <xsl:variable name=“gathered.nodes” select=“msxml:node-set($gathered.nodes.tf)” />
  <!-- output updategram -->
  <xsl:for-each select=“$gathered.nodes/*” >
    <xsl:copy-of select=“.” />
  </xsl:for-each>
</xsl:template>
</xsl:stylesheet>
```

The Updategram generated by transforming the XML document with the above XSL stylesheet is then inserted into the SQL Server 2000 database using the algorithm of the Preferred Embodiment.

### Alternate Embodiment 6

Alternate Embodiment 6 of this invention will now be described with reference to FIGS. 9A-9C. FIG. 9A is a generic XML document containing the minimally required top-level elements, <?xml/?> and <doc>. In this document, the root element <doc> also contains a namespace attribute.

Database Tables

FIGS. 9B and 9C show the database tables and rows corresponding to the above XML document according to the teachings of this invention. In this Embodiment, these tables are created in the SQL-compliant database SQL Server 2000, a product of Microsoft Corporation.

The database tables in this Alternate Embodiment 6 are constructed as for those in the Alternate Embodiment 5 with the exception that the StringID columns in StringTable and LocationPathTable are globally unique identifiers.

The string table shown in FIG. 9B consists of two columns: StringID and String. This table is created in SQL Server 2000 using the following SQL script.

```
create table StringTable
(
  StringID uniqueidentifier ROWGUIDCOL not null primary key,
  String nvarchar(4000) not null
)
```

StringID is a ROWGUIDCOL identity column as described in Vieira, p.157. String is a variable length column that holds up to 4000 Unicode characters and contains text( ) elements from the XML document in FIG. 9A.

```
create table LocationPathTable
(
  StringID uniqueidentifier not null foreign key references
  StringTable(StringID) primary key,
  LocationPath varchar(256)
)
```

LocationPath is the absolute location path of the string in StringTable corresponding to StringID.

Method for Inserting Data in Tables Based on an XML Document

In this Alternate Embodiment 6, data is inserted into the above tables from an XML document using an Updategram that is generated using an XSL stylesheet. This method is shown in FIG. 3. The XSL stylesheet in Alternate Embodiment 5 is used to generate an Updategram that is then used to insert the textual strings of the XML document into SQL Server 2000 as taught in Burke et al.

### Alternate Embodiment 7

Alternate Embodiment 7 of this invention will now be described with reference to FIGS. 10A and 10B. FIG. 10A is a generic XML document containing the minimally required top-level elements, <?xml/?> and <doc>. In this document, the root element <doc> also contains a namespace attribute.

Database Tables

FIG. 10B shows the database table and rows corresponding to the above XML document according to the teachings of this invention. In this Embodiment, these tables are created in the SQL-compliant database SQL Server 2000, a product of Microsoft Corporation.

The string table shown in FIG. 10B consists of two columns: StringID and String. This table is created in SQL Server 2000 using the following SQL script.

```
create table StringTable
(
  String nvarchar(4000) not null,
  LocationPath varchar(256)
)
```

Method for Inserting Data in Tables Based on an XML Document

In this Alternate Embodiment 7, data is inserted into the above tables from an XML document using an Updategram that is generated using an XSL stylesheet. This method is shown in FIG. 3. The XSL stylesheet in below is used to generate an Updategram that is then used to insert the textual strings of the XML document into SQL Server 2000 as taught in Burke et al.

```
<?xml version=“1.0” encoding=“UTF-16” standalone=“yes”?>
<xsl:stylesheet version=“1.0” xmlns:xsl=“http://www.w3.org/1999/XSL/Transform”
  xmlns:msxml=“urn:schemas-microsoft-com:xslt”
  xmlns:updg=“urn:schemas-microsoft-com:xml-updategram”
  xmlns:p=“urn:schemas-paterra-com”
  xmlns:dt=“urn:schemas-microsoft-com:datatypes”
  xmlns:pi=“urn:schemas-pi-paterra-com”
  >
<xsl:template match=“/”>
  <ROOT>
    <updg:sync>
      <xsl:call-template name=“top” />
      </updg:sync>
  </ROOT>
</xsl:template>
<xsl:template name=“top” >
  <!-- gather strings and names of string ids from tree -->
  <xsl:variable name=“gathered.strings.tf” >
    <xsl:call-template name=“gatherstrings”/>
  </xsl:variable>
  <xsl:variable name=“gathered.strings” select=“msxml:node-set($gathered.strings.tf)” />
  <!-- output updategram -->
  <xsl:for-each select=“$gathered.strings/*” >
    <xsl:choose>
      <xsl:when test=“ name( ) = ‘pi:String’ ” >
        <updg:before />
        <updg:after >
          <StringTable>
            <xsl:attribute name=“String” ><xsl:value-of select=“@content” /></xsl:attribute>
            <xsl:attribute name=“LocationPath” ><xsl:value-of select=“@path” /></xsl:attribute>
          </StringTable>
        </updg:after>
      </xsl:when>
    </xsl:choose>
  </xsl:for-each>
</xsl:template>
<!-- The code below is the same as for the Alternate Embodiment 5 and is here omitted for brevity. -->
```

### Alternate Embodiment 8

Alternate Embodiment 8 is identical to Alternate 5 except in the definition of StringTable. In this Alternate Embodiment 8, the string table shown in FIG. 8B consists of two columns: StringID and String. This table is created in SQL Server 2000 using the following SQL script.

```
create table StringTable
(
  StringID bigint identity(1,1) not null primary key,
  String ntext not null
)
```

### Alternate Embodiment 9

Alternate Embodiment 9 of this invention will now be described with reference to FIGS. 11A-11E. FIG. 11A is a generic XML document containing the minimally required top-level elements, <?xml/?> and <doc>. In this document, the root element <doc> also contains a namespace attribute.

Database Tables

FIGS. 11B through 11D show the database tables and rows corresponding to the above XML document according to the teachings of this invention. In this Embodiment, these tables are created in the SQL-compliant database SQL Server 2000, a product of Microsoft Corporation.

StringTable (FIG. 11B), LocationPathTable (FIG. 11C) and StringElementTable (FIG. 11D) are constructed as for those in Alternate Embodiment 2 with the addition of an attribute table (FIG. 11E). This table is created in SQL Server 2000 using the following SQL script.

```
create table AttributeTable
(
  ElementID bigint not null foreign key references
  LocationPathTable(ElementID)primary key,
  Name varchar(256),
  Value nvarchar(256)
)
```

AttributeTable is related to LocationPathTable on the ElementID column. Name is the name of an attribute of the lowest element of the LocationPath corresponding to ElementID and Value is the value of that attribute.

Method for Inserting Data in Tables Based on an XML Document

In this Alternate Embodiment 9, data is inserted into the above tables from an XML document using an Updategram that is generated using an XSL stylesheet. This method is shown in FIG. 3. The XSL stylesheet below is used to generate an Updategram that is then used to insert the textual strings of the XML document into SQL Server 2000 as taught in Burke et al.

```
<?xml version=“1.0” encoding=“UTF-16” standalone=“yes”?>
<xsl:stylesheet version=“1.0” xmlns:xsl=“http://www.w3.org/1999/XSL/Transform”
  xmlns:msxml=“urn:schemas-microsoft-com:xslt”
  xmlns:updg=“urn:schemas-microsoft-com:xml-updategram”
  xmlns:p=“urn:schemas-paterra-com”
  xmlns:dt=“urn:schemas-microsoft-com:datatypes”
  xmlns:pi=“urn:schemas-pi-paterra-com”
  >
<xsl:template match=“/”>
  <ROOT>
      <updg:sync>
        <xsl:call-template name=“top” />
      </updg:sync>
  </ROOT>
</xsl:template>
<xsl:template name=“top” >
  <!-- gather strings and names of string ids from tree -->
  <xsl:variable name=“gathered.strings.tf” >
    <xsl:call-template name=“gatherstrings”/>
  </xsl:variable>
  <xsl:variable name=“gathered.strings” select=“msxml:node-set($gathered.strings.tf)” />
  <!-- output updategram -->
  <xsl:for-each select=“$gathered.strings/*” >
    <xsl:choose>
      <xsl:when test=“ name( ) = ‘pi:String’ ” >
        <updg:before />
        <updg:after >
          <StringTable>
            <xsl:attribute name=“updg:at-identity” ><xsl:value-of select=“@idname” /></xsl:attribute>
            <xsl:attribute name=“String” ><xsl:value-of select=“@content” /></xsl:attribute>
          </StringTable>
        </updg:after>
      </xsl:when>
      <xsl:when test=“ name( ) = ‘pi:PathElem’ ” >
        <updg:before />
        <updg:after >
          <LocationPathTable>
            <xsl:attribute name=“updg:at-identity” >elementidentity</xsl:attribute>
            <xsl:attribute name=“LocationPath” ><xsl:value-of select=“@path” /></xsl:attribute>
          </LocationPathTable>
        </updg:after>
        <updg:before />
        <updg:after >
          <StringElementTable >
            <xsl:attribute name=“ElementID” >elementidentity</xsl:attribute>
            <xsl:attribute name=“FirstString”><xsl:value-of select=“@firststringid” /></xsl:attribute>
            <xsl:attribute name=“LastString”><xsl:value-of select=“@laststringid” /></xsl:attribute>
            <xsl:attribute name=“Element” ><xsl:value-of select=“@field” /></xsl:attribute
          </StringElementTable>
        </updg:after>
        <xsl:for-each select=“./pi:Attribute”>
          <AttributeTable>
            <xsl:attribute name=“Name” ><xsl:value-of select=“@Name” /></xsl:attribute>
            <xsl:attribute name=“Value” ><xsl:value-of select=“@Value” /></xsl:attribute>
          </AttributeTable>
        </xsl:for-each>
      </xsl:when>
    </xsl:choose>
  </xsl:for-each>
</xsl:template>
<xsl:template name=“gatherstrings” >
  <xsl:param name=“idname” select=“‘id’” />
  <xsl:param name=“docpath” select=“dummy” />
  <!-- gather strings and names of string ids from tree -->
  <xsl:variable name=“gathered.nodes.tf” >
<xsl:for-each select=“child::*” >
  <xsl:variable name=“thisPosition” select=“count(preceding-sibling::*[name(current( )) = name( )])”
/>
  <xsl:choose>
    <xsl:when test=“current( ) = text( )” >
      <xsl:variable name=“textidstr” select=“concat( $idname, ‘_’, position( ) )” />
      <pi:String>
        <xsl:attribute name=“idname”>
          <xsl:value-of select=“$textidstr” />
        </xsl:attribute>
        <xsl:attribute name=“content” >
          <xsl:value-of select=“.” />
        </xsl:attribute>
        <xsl:attribute name=“path” >
          <xsl:value-of select=“concat($docpath,‘/p:’,name( ),‘[‘,$thisPosition+1,’]’)” />
        </xsl:attribute>
      </pi:String>
      <pi:PathElem>
        <xsl:attribute name=“field” >
          <xsl:value-of select=“name( )” />
        </xsl:attribute>
        <xsl:attribute name=“firststringid”>
        <xsl:value-of select=“concat( $idname, ‘_’, position( ) )” />
        </xsl:attribute>
        <xsl:attribute name=“laststringid”>
        <xsl:value-of select=“concat( $idname, ‘_’, position( ) )” />
        </xsl:attribute>
        <xsl:attribute name=“path” >
          <xsl:value-of select=“concat($docpath,‘/p:’,name( ),‘[‘,$thisPosition+1,’]’)” />
        </xsl:attribute>
        <xsl:for-each select=“attribute::*” >
          <pi:Attribute>
            <xsl:attribute name=“Name” ><xsl:value-of select=“name( )” /></xsl:attribute>
            <xsl:attribute name=“Value” ><xsl:value-of select=“.” /></xsl:attribute>
          </pi:Attribute>
        </xsl:for-each>
      </pi:PathElem>
          </xsl:when>
          <xsl:otherwise>
              <xsl:call-template name=“gatherstrings”>
                <xsl:with-param name=“idname” ><xsl:value-of select=“concat( $idname, ‘_’, position( ) )”
/></xsl:with-param>
                <xsl:with-param name=“docpath” ><xsl:value-of
select=“concat($docpath,‘/p:’,name( ),‘[‘,$thisPosition+1,’]’)” /></xsl:with-param>
              </xsl:call-template>
          </xsl:otherwise>
        </xsl:choose>
      </xsl:for-each>
    </xsl:variable>
  <xsl:variable name=“gathered.nodes” select=“msxml:node-set($gathered.nodes.tf)” />
  <!-- output updategram -->
  <xsl:for-each select=“$gathered.nodes/*” >
    <xsl:copy-of select=“.” />
  </xsl:for-each>
  <xsl:if test=“ name( ) != “ ” >
    <xsl:if test=“$gathered.nodes/pi:String[1]/@idname != “ ” >
      <pi:PathElem>
        <xsl:attribute name=“field” >
          <xsl:value-of select=“name( )” />
        </xsl:attribute>
        <xsl:attribute name=“firststringid”>
          <xsl:value-of select=“$gathered.nodes/pi:String[1]/@idname” />
        </xsl:attribute>
        <xsl:attribute name=“laststringid”>
          <xsl:value-of select=“$gathered.nodes/pi:String[last( )]/@idname” />
        </xsl:attribute>
        <xsl:attribute name=“path” >
          <xsl:value-of select=“$docpath” />
        </xsl:attribute>
      </pi:PathElem>
    </xsl:if>
  </xsl:if>
</xsl:template>
</xsl:stylesheet>
```

### Alternate Embodiment 10

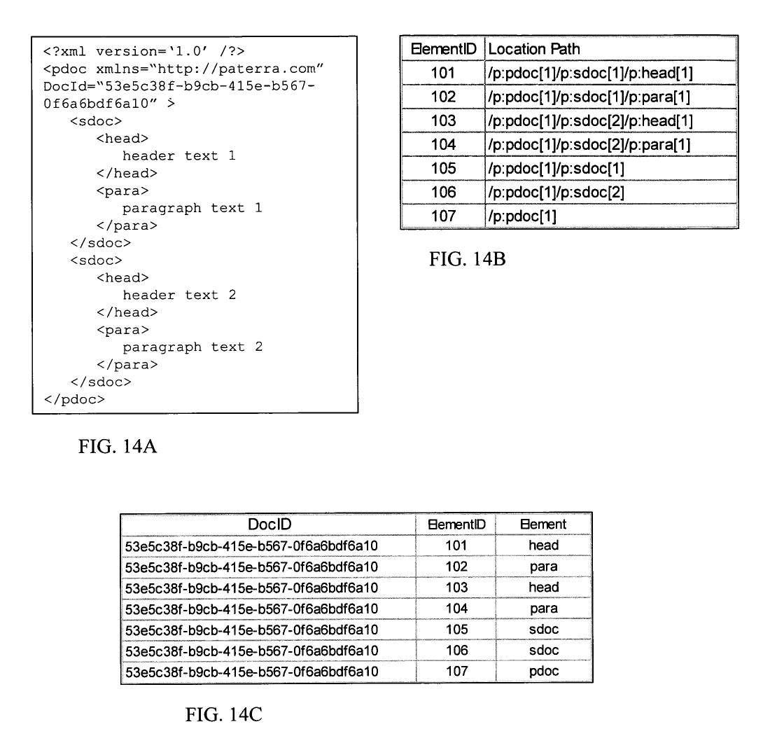

Alternate Embodiment 10 of this invention will now be described with reference to FIGS. 14A-14C. FIG. 14A is a generic XML document containing the minimally required top-level elements, <?xml/?> and <doc>. In this document, the root element <doc> also contains a namespace attribute.

Database Tables

FIGS. 14B and 14C show the database tables and rows corresponding to the above XML document according to the teachings of this invention. In this Embodiment, these tables are created in the SQL-compliant database SQL Server 2000, a product of Microsoft Corporation.

LocationPathTable (FIG. 14B) is constructed as in the Preferred Embodiment. An element table (FIG. 14C) is created in SQL Server 2000 using the following SQL script.

```
create table ElementTable
(
  DocID uniqueidentifier not null,
  ElementID bigint not null foreign key references
  LocationPathTable(ElementID)primary key,
  Element varchar(256) not null
)
```

DocID is the value of the attribute DocID of element pdoc in the XML document. StringElementTable is related to LocationPathTable on the ElementID column. Element is the name of the last element in this LocationPath.

Method for Inserting Data in Tables Based on an XML Document

In this Alternate Embodiment 10, data is inserted into the above tables from an XML document using an Updategram that is generated using an XSL stylesheet. This method is shown in FIG. 3. The XSL stylesheet below is used to generate an Updategram that is then used to insert the textual strings of the XML document into SQL Server 2000 as taught in Burke et al.

```
<?xml version=“1.0” encoding=“UTF-16” standalone=“yes”?>
<xsl:stylesheet version=“1.0” xmlns:xsl=“http://www.w3.org/1999/XSL/Transform”
  xmlns:msxml=“urn:schemas-microsoft-com:xslt”
  xmlns:updg=“urn:schemas-microsoft-com:xml-updategram”
  xmlns:p=“urn:schemas-paterra-com”
  xmlns:dt=“urn:schemas-microsoft-com:datatypes”
  xmlns:pi=“urn:schemas-pi-paterra-com”
  >
<xsl:variable name=“DefaultID” select=“defaultid” />
<xsl:template match=“/”>
  <ROOT>
    <updg:sync>
      <xsl:call-template name=“top” >
        <xsl:with-param name=“DocID” select=“$docid” />
        </xsl:call-template>
      </updg:sync>
  </ROOT>
</xsl:template>
<xsl:template name=“top” >
  <xsl:param name=“DocID” />
  <!-- gather strings and names of string ids from tree -->
  <xsl:variable name=“gathered.strings.tf” >
    <xsl:call-template name=“gatherstrings”/>
  </xsl:variable>
  <xsl:variable name=“gathered.strings” select=“msxml:node-set($gathered.strings.tf)” />
  <!-- output updategram -->
  <xsl:for-each select=“$gathered.strings/*” >
    <xsl:choose>
      <xsl:when test=“ name( ) = ‘pi:PathElem’ ” >
        <updg:before />
        <updg:after >
          <LocationPathTable>
            <xsl:attribute name=“updg:at-identity” >elementidentity</xsl:attribute>
            <xsl:attribute name=“LocationPath” ><xsl:value-of select=“@path” /></xsl:attribute>
          </LocationPathTable>
        </updg:after>
        <updg:before />
        <updg:after >
          <ElementTable >
            <xsl:attribute name=“ElementID” >elementidentity</xsl:attribute>
            <xsl:attribute name=“DocID” ><xsl:value-of select=“$DocID” /></xsl:attribute>
            <xsl:attribute name=“Element” ><xsl:value-of select=“@field” /></xsl:attribute>
          </ElementTable>
        </updg:after>
      </xsl:when>
    </xsl:choose>
  </xsl:for-each>
</xsl:template>
<xsl:template name=“gatherstrings” >
  <xsl:param name=“idname” select=“‘id’” />
  <xsl:param name=“docpath” select=“dummy” />
  <!-- gather strings and names of string ids from tree -->
  <xsl:variable name=“gathered.nodes.tf” >
      <xsl:for-each select=“child::*” >
        <xsl:variable name=“thisPosition” select=“count(preceding-sibling::*[name(current( )) = name( )])”
/>
        <xsl:choose>
          <xsl:when test=“current( ) = text( )” >
            <xsl:variable name=“textidstr” select=“concat( $idname, ‘_’, position( ) )” />
            <pi:PathElem>
              <xsl:attribute name=“field” >
                <xsl:value-of select=“name( )” />
              </xsl:attribute>
              <xsl:attribute name=“path” >
                <xsl:value-of select=“concat($docpath,‘/p:’,name( ),‘[‘,$thisPosition+1,’]’)” />
              </xsl:attribute>
            </pi:PathElem>
          </xsl:when>
          <xsl:otherwise>
              <xsl:call-template name=“gatherstrings”>
                <xsl:with-param name=“idname” ><xsl:value-of select=“concat( $idname, ‘_’, position( ) )”
/></xsl:with-param>
                <xsl:with-param name=“docpath” ><xsl:value-of
select=“concat($docpath,‘/p:’,name( ),‘[‘,$thisPosition+1,’]’)” /></xsl:with-param>
              </xsl:call-template>
          </xsl:otherwise>
        </xsl:choose>
      </xsl:for-each>
  </xsl:variable>
  <xsl:variable name=“gathered.nodes” select=“msxml:node-set($gathered.nodes.tf)” />
  <!-- output updategram -->
  <xsl:for-each select=“$gathered.nodes/*” >
    <xsl:copy-of select=“.” />
  </xsl:for-each>
  <xsl:if test=“ name( ) !=“ ”>
    <xsl:if test=“$gathered.nodes/pi:String[1]/@idname != “ ” >
      <pi:PathElem>
        <xsl:attribute name=“field” >
          <xsl:value-of select=“name( )” />
        </xsl:attribute>
        <xsl:attribute name=“path” >
          <xsl:value-of select=“$docpath” />
        </xsl:attribute>
      </pi:PathElem>
    </xsl:if>
  </xsl:if>
</xsl:template>
</xsl:stylesheet>
```

The Updategram generated by transforming the XML document with the above XSL stylesheet is then inserted into the SQL Server 2000 database using the algorithm of the Preferred Embodiment.

### Alternate Embodiment 11

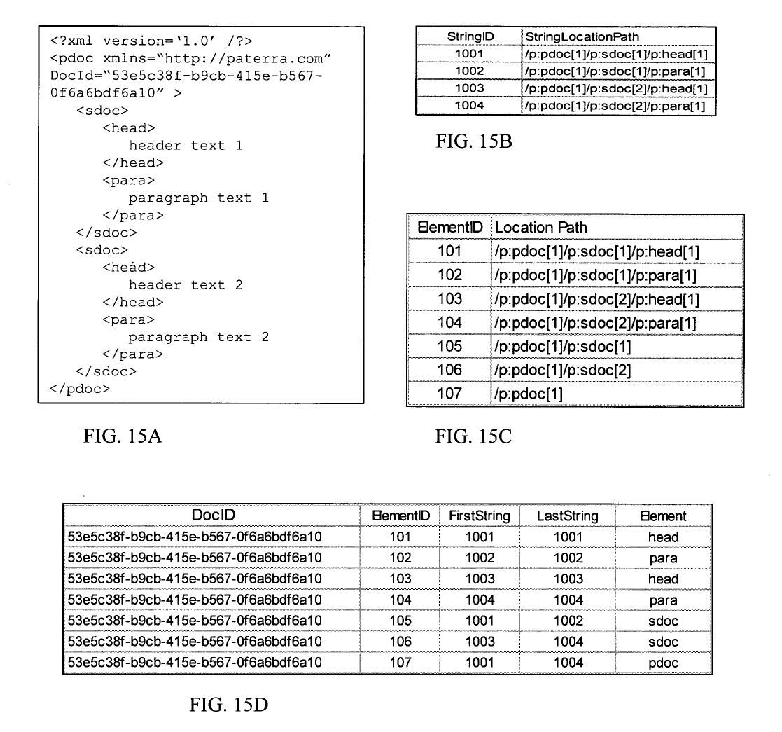

Alternate Embodiment 11 of this invention will now be described with reference to FIGS. 15A-15D. FIG. 15A is a generic XML document containing the minimally required top-level elements, <?xml/?> and <doc>. In this document, the root element <doc> also contains a namespace attribute.

Database Tables

FIGS. 14B and 14C show the database tables and rows corresponding to the above XML document according to the teachings of this invention. In this Embodiment, these tables are created in the SQL-compliant database SQL Server 2000, a product of Microsoft Corporation.

LocationPathTable (FIG. 15B) and StringElementTable (FIG. 15C) are constructed as for those in the Preferred Embodiment. A string-path table (FIG. 15A) is created in SQL Server 2000 using the following SQL script.

```
create table StringPathTable
(
  StringID bigint not null foreign key references
  LocationPathTable(ElementID)primary key,
  Path varchar(256) not null
)
```

StringID is an identifier assigned by the database system and corresponds to a textual element in the document. Path is the unambiguous location path corresponding to the textual element.

Method for Inserting Data in Tables Based on an XML Document

In this Preferred Embodiment, data is inserted into the above tables from an XML document using an Updategram that is generated using an XSL stylesheet. This method is shown in FIG. 3. The XSL stylesheet below is used to generate an Updategram that is then used to insert the textual strings of the XML document into SQL Server 2000 as taught in Burke et al.

```
<?xml version=“1.0” encoding=“UTF-16” standalone=“yes”?>
<xsl:stylesheet version=“1.0” xmlns:xsl=“http://www.w3.org/1999/XSL/Transform”
  xmlns:msxml=“urn:schemas-microsoft-com:xslt”
  xmlns:updg=“urn:schemas-microsoft-com:xml-updategram”
  xmlns:p=“urn:schemas-paterra-com”
  xmlns:dt=“urn:schemas-microsoft-com:datatypes”
  xmlns:pi=“urn:schemas-pi-paterra-com”
  >
<xsl:template match=“/”>
  <ROOT>
    <updg:sync>
      <xsl:call-template name=“top” >
        <xsl:with-param name=“DocID” select=“$docid” />
      </xsl:call-template>
      </updg:sync>
  </ROOT>
</xsl:template>
<xsl:template name=“top” >
  <xsl:param name=“DocID” />
  <!-- gather strings and names of string ids from tree -->
  <xsl:variable name=“gathered.strings.tf” >
    <xsl:call-template name=“gatherstrings”/>
  </xsl:variable>
  <xsl:variable name=“gathered.strings” select=“msxml:node-set($gathered.strings.tf)” />
  <!-- output updategram -->
  <xsl:for-each select=“$gathered.strings/*” >
    <xsl:choose>
      <xsl:when test=“ name( ) = ‘pi:String’ ” >
        <updg:before />
        <updg:after >
          <StringPathTable>
            <xsl:attribute name=“updg:at-identity” ><xsl:value-of select=“@idname” /></xsl:attribute>
            <xsl:attribute name=“String” ><xsl:value-of select=“@path” /></xsl:attribute>
          </StringPathTable>
        </updg:after>
      </xsl:when>
      <xsl:when test=“ name( ) = ‘pi:PathElem’ ” >
        <updg:before />
        <updg:after >
          <LocationPathTable>
            <xsl:attribute name=“updg:at-identity” >elementidentity</xsl:attribute>
            <xsl:attribute name=“LocationPath” ><xsl:value-of select=“@path” /></xsl:attribute>
          </LocationPathTable>
        </updg:after>
        <updg:before />
        <updg:after >
          <StringElementTable >
            <xsl:attribute name=“ElementID” >elementidentity</xsl:attribute>
            <xsl:attribute name=“DocID” ><xsl:value-of select=“$DocID” /></xsl:attribute>
            <xsl:attribute name=“FirstString”><xsl:value-of select=“@firststringid” /></xsl:attribute>
            <xsl:attribute name=“LastString”><xsl:value-of select=“@laststringid” /></xsl:attribute>
            <xsl:attribute name=“Element” ><xsl:value-of select=“@field” /></xsl:attribute>
          </StringElementTable>
        </updg:after>
      </xsl:when>
    </xsl:choose>
  </xsl:for-each>
</xsl:template>
<xsl:template name=“gatherstrings” >
  <xsl:param name=“idname” select=“‘id’” />
  <xsl:param name=“docpath” select=“dummy” />
  <!-- gather strings and names of string ids from tree -->
  <xsl:variable name=“gathered.nodes.tf” >
      <xsl:for-each select=“child::*” >
        <xsl:variable name=“thisPosition” select=“count(preceding-sibling::*[name(current( )) = name( )])”
/>
      <xsl:choose>
        <xsl:when test=“current( ) = text( )” >
          <xsl:variable name=“textidstr” select=“concat( $idname, ‘_’, position( ) )” />
          <pi:String>
            <xsl:attribute name=“idname”>
              <xsl:value-of select=“$textidstr” />
            </xsl:attribute>
            <xsl:attribute name=“path” >
              <xsl:value-of select=“concat($docpath,‘/p:’,name( ),‘[’,$thisPosition+1,‘]’)” />
            </xsl:attribute>
          </pi:String>
          <pi:PathElem>
            <xsl:attribute name=“field” >
              <xsl:value-of select=“name( )” />
            </xsl:attribute>
            <xsl:attribute name=“firststringid”>
            <xsl:value-of select=“concat( $idname, ‘_’, position( ) )” />
            </xsl:attribute>
            <xsl:attribute name=“laststringid”>
            <xsl:value-of select=“concat( $idname, ‘_’, position( ) )” />
            </xsl:attribute>
            <xsl:attribute name=“path” >
              <xsl:value-of select=“concat($docpath,‘/p:’,name( ),‘[’,$thisPosition+1,‘]’)” />
            </xsl:attribute>
          </pi:PathElem>
        </xsl:when>
        <xsl:otherwise>
            <xsl:call-template name=“gatherstrings”>
              <xsl:with-param name=“idname” ><xsl:value-of select=“concat( $idname, ‘_’, position( ) )”
/></xsl:with-param>
              <xsl:with-param name=“docpath” ><xsl:value-of
select=“concat($docpath,‘/p:’,name( ),‘[’,$thisPosition+1,‘]’)” /></xsl:with-param>
            </xsl:call-template>
        </xsl:otherwise>
      </xsl:choose>
    </xsl:for-each>
  </xsl:variable>
  <xsl:variable name=“gathered.nodes” select=“msxml:node-set($gathered.nodes.tf)” />
  <!-- output updategram -->
  <xsl:for-each select=“$gathered.nodes/*” >
    <xsl:copy-of select=“.” />
  </xsl:for-each>
  <xsl:if test=“ name( ) != ” “>
    <xsl:if test=”$gathered.nodes/pi:String[1]/@idname !=“ ” >
      <pi:PathElem>
        <xsl:attribute name=“field” >
          <xsl:value-of select=“name( )” />
        </xsl:attribute>
        <xsl:attribute name=“firststringid”>
          <xsl:value-of select=“$gathered.nodes/pi:String[1]/@idname” />
        </xsl:attribute>
        <xsl:attribute name=“laststringid”>
          <xsl:value-of select=“$gathered.nodes/pi:String[last( )]/@idname” />
        </xsl:attribute>
        <xsl:attribute name=“path” >
          <xsl:value-of select=“$docpath” />
        </xsl:attribute>
      </pi:PathElem>
    </xsl:if>
  </xsl:if>
</xsl:template>
</xsl:stylesheet>
```

The Updategram generated by transforming the XML document with the above XSL stylesheet is then inserted into the SQL Server 2000 database using the algorithm of the Preferred Embodiment.

### Alternate Embodiment 12

Alternate Embodiment 12 of this invention will now be described with reference to FIGS. 16 and 17. This Alternate Embodiment is identical to the Preferred Embodiment with the exception that, instead of an intermediate updategram, intermediate SQL script document 104sql is produced by means of XSLT transformation 103sql. Intermediate SQL script document 104sql is applied to SQL Server by means documented with the server system and known to those skilled in the art.

XSLT transformation 103sql is specified by the following XSL stylesheet:

```
<?xml version=“1.0” encoding=“UTF-16” standalone=“yes”?>
<xsl:stylesheet version=“1.0” xmlns:xsl=“http://www.w3.org/1999/XSL/Transform”
  xmlns:msxml=“urn:schemas-microsoft-com:xslt”
  xmlns:updg=“urn:schemas-microsoft-com:xml-updategram”
  xmlns:p=“urn:schemas-paterra-com”
  xmlns:dt=“urn:schemas-microsoft-com:datatypes”
  xmlns:pi=“urn:schemas-pi-paterra-com”
  >
<xsl:output method=“text” omit-xml-declaration=“yes” media-type=“text/sql” />
<xsl:variable name=“DefaultID” select=“defaultid” />
<xsl:template match=“/”>
<xsl:text disableoutput-escaping=“yes”>declare @docid uniqueidentifier
  declare @elemid int
  set @docid =‘</xsl:text><xsl:value-of select=“$docid” /><xsl:text disableoutput-escaping=“yes”>’
</xsl:text>
  <xsl:text disableoutput-escaping=“yes”>begin transaction
</xsl:text>
  <xsl:call-template name=“top” / >
  <xsl:text disableoutput-escaping=“yes”>commit transaction
</xsl:text>
</xsl:template>
<xsl:template name=“top” >
  <!-- gather strings and names of string ids from tree -->
  <xsl:variable name=“gathered.strings.tf” >
    <xsl:call-template name=“gatherstrings”/>
  </xsl:variable>
  <xsl:variable name=“gathered.strings” select=“msxml:node-set($gathered.strings.tf)” />
  <!-- output updategram -->
  <xsl:for-each select=“$gathered.strings/*” >
    <xsl:choose>
      <xsl:when test=“ name( ) = ‘pi:String’ ” >
      <xsl:text disableoutput-escaping=“yes”>declare @</xsl:text>
      <xsl:value-of select=“@idname” /><xsl:text disableoutput-escaping=“yes”> int</xsl:text>
      <xsl:text disableoutput-escaping=“yes”>insert into StringTable (String) values ( ‘</xsl:text>
      <xsl:value-of select=“@content” />
      <xsl:text disableoutput-escaping=“yes”>’ )</xsl:text>
      <xsl:text disableoutput-escaping=“yes”>set @</xsl:text>
      <xsl:value-of select=“@idname” />
      <xsl:text disableoutput-escaping=“yes”>=@@IDENTITY</xsl:text>
      </xsl:when>
      <xsl:when test=“ name( ) = ‘pi:PathElem’ ” >
<xsl:text disableoutput-escaping=“yes”>insert into LocationPathTable (LocationPath) values ( ‘</xsl:text>
<xsl:value-of select=“@path” />
<xsl:text disableoutput-escaping=“yes”>’ )
</xsl:text>
<xsl:text disableoutput-escaping=“yes”>set @elemid=@@IDENTITY
</xsl:text>
<xsl:text disableoutput-escaping=“yes”>insert into StringElementTable( ElementID, DocID, FirstString,
LastString, Element)
values ( @elemid, @docid, @</xsl:text>
<xsl:value-of select=“@firststringid” />
<xsl:text disableoutput-escaping=“yes”>, @</xsl:text>
<xsl:value-of select=“@laststringid” />
<xsl:text disableoutput-escaping=“yes”>, ‘</xsl:text>
<xsl:value-of select=“@field” />
<xsl:text disableoutput-escaping=“yes”>’ )
</xsl:text>
      </xsl:when>
    </xsl:choose>
  </xsl:for-each>
</xsl:template>
<!-- The code below is the same as for the Preferred Embodiment and is here omitted for brevity. -->
```

I claim:

1. A method of storing data from at least one tree-structured document in a data store connected to a computer, the method comprising extracting at least one unambiguous location path from said tree-structured document; and inserting said unambiguous location path into at least one table.

2. The method of claim 1, wherein the tree-structured document is in a markup language that conforms to the extensible markup language.

3. The method of claim 1, wherein said location path is extracted from said tree-structured document and formed into an intermediate document, and said location path is inserted into said table by applying said intermediate document to a relational database system.

4. The method of claim 3, wherein said intermediate document is an SQL script document.

5. The method of claim 3, wherein said intermediate document conforms to a database extender; and said location path is inserted in said table by applying said intermediate document to said database extender.

6. The method of claim 5, wherein said intermediate document is an updategram that conforms to Microsoft Corporation's XML for SQL Server and said column is in a Microsoft Corporation SQL Server database.

7. A method of storing data from at least one tree-structured document in a data store connected to a computer, the method comprising extracting at least one textual element from said tree-structured document together with unambiguous location paths corresponding to the extracted textual element, and inserting said extracted textual elements into one column of a table and said location paths into a second column that is in a one-to-one relationship to the first column.

8. The method of claim 7, wherein the tree-structured document is in a markup language that conforms to the extensible markup language.

9. The method of claim 7, wherein said extracted textual elements and said location paths are stored as rows in two columns in a single table.

10. The method of claim 7, wherein said extracted textual elements and said location paths are stored in separate tables that are in a one-to-one relationship by means of a key.

11. The method of claim 7, wherein said location paths are extracted from said tree-structured document and formed into an intermediate document, and said location paths are inserted into said table by applying said intermediate document to a relational database system.

12. The method of claim 11, wherein said intermediate document is an SQL script document.

13. The method of claim 11, wherein said intermediate document conforms to a database extender; and said location paths are inserted in said table by applying said intermediate document to said database extender.

14. The method of claim 13, wherein said intermediate document is an updategram that conforms to Microsoft Corporation's XML for SQL Server and said column is in a Microsoft Corporation SQL Server database.

15. A method of storing data from at least one tree-structured document in a data store connected to a computer, the method comprising
extracting at least one textual element from said document together with, for at least one textual element, at least one unambiguous location path corresponding to said extracted textual elements or to ancestor elements of said textual elements;
inserting said extracted textual elements into one column of a first table that also contains an identity column; and
inserting rows into a second table, said rows comprising an unambiguous location path selected from the above unambiguous location paths, the identity of the first extracted textual element that is a descendent of said location path, and the identity of the last extracted textual element that is a descendent of said location path, said identities being the corresponding identities of said textual elements in said first table.

16. The method of claim 15, wherein the document is an extensible markup language document.

17. The method of claim 15, wherein said location paths are extracted from said tree-structured document and formed into an intermediate document, and said location paths are inserted into said table by applying said intermediate document to a relational database system.

18. The method of claim 17, wherein said intermediate document is an SQL script document.

19. The method of claim 17, wherein said intermediate document conforms to a database extender; and said location paths are inserted in said table by applying said intermediate document to said database extender.

20. The method of claim 19, wherein said intermediate document is an updategram that conforms to Microsoft Corporation's XML for SQL Server and said column is in a Microsoft Corporation SQL Server database.

21. A method of storing data from at least one tree-structured document in a data store connected to a computer, the method comprising
extracting at least one unambiguous location path corresponding to at least one textual element in said document or to at least one ancestor element of at least one textual element in said document;
inserting at least one unambiguous location path corresponding to said textual elements into one column of a first table that also contains an identity column; and
inserting at least one row into a second table, said row comprising an unambiguous location path selected from the above extracted unambiguous location paths, the identity of the location path in the first table that corresponds to the first corresponding textual element that is a descendent of said location path, and the identity of the location path in the first table that corresponds to the last corresponding textual element that is a descendent of said location path.

22. The method of claim 21, wherein the document is an extensible markup language document.

23. The method of claim 21, wherein said location paths are extracted from said tree-structured document and formed into an intermediate document, and said location paths are inserted into said table by applying said intermediate document to a relational database system.

24. The method of claim 23, wherein said intermediate document is an SQL script document.

25. The method of claim 23, wherein said intermediate document conforms to a database extender; and said location paths are inserted in said table by applying said intermediate document to said database extender.

26. The method of claim 25, wherein said intermediate document is an updategram that conforms to Microsoft Corporation's XML for SQL Server and said column is in a Microsoft Corporation SQL Server database.

27. The method of claim 15 wherein the rows inserted into said second table further comprise the name of the element specified by said location path.

28. The method of claim 27, wherein the document is an extensible markup language document.

29. The method of claim 27, wherein said location paths are extracted from said tree-structured document and formed into an intermediate document, and said location paths are inserted into said table by applying said intermediate document to a relational database system.

30. The method of claim 29, wherein said intermediate document is an SQL script document.

31. The method of claim 29, wherein said intermediate document conforms to a database extender; and said location paths are inserted in said table by applying said intermediate document to said database extender.

32. The method of claim 31, wherein said intermediate document is an updategram that conforms to Microsoft Corporation's XML for SQL Server and said column is in a Microsoft Corporation SQL Server database.

33. The method of claim 21 wherein the rows inserted into said second table further comprise the name of the element specified by said location path.

34. The method of claim 33, wherein the document is an extensible markup language document.

35. The method of claim 33, wherein said location paths are extracted from said tree-structured document and formed into an intermediate document, and said location paths are inserted into said table by applying said intermediate document to a relational database system.

36. The method of claim 35, wherein said intermediate document is an SQL script document.

37. The method of claim 35, wherein said intermediate document conforms to a database extender; and said location paths are inserted in said table by applying said intermediate document to said database extender.

38. The method of claim 37, wherein said intermediate document is an updategram that conforms to Microsoft Corporation's XML for SQL Server and said column is in a Microsoft Corporation SQL Server database.

39. An apparatus for storing data in a data store comprising a computer having a data store coupled thereto, wherein the data store stores data; and one or more computer programs, performed by the computer, that perform extraction of at least one unambiguous location path from said tree-structured document; and inserting said unambiguous location path into at least one table.

40. The apparatus of claim 39, wherein the document is an extensible markup language document.

41. The apparatus of claim 39, wherein said location path is extracted from said tree-structured document and formed into an intermediate document, and said location path is inserted into said table by applying said intermediate document to a relational database system.

42. The apparatus of claim 41, wherein said intermediate document is an SQL script document.

43. The apparatus of claim 41, wherein said intermediate document conforms to a database extender; and said location path is inserted in said table by applying said intermediate document to said database extender.

44. The apparatus of claim 43, wherein said intermediate document is an updategram that conforms to Microsoft Corporation's XML for SQL Server and said column is in a Microsoft Corporation SQL Server database.

45. An apparatus for storing data in a data store comprising a computer having a data store coupled thereto, wherein the data store stores data; and one or more computer programs, performed by the computer, that perform
extraction of at least one textual element from said tree-structured document together with unambiguous location paths corresponding to the extracted textual element, and
insertion of said extracted textual elements into one column of a table and said location paths into a second column that is in a one-to-one relationship to the first column.

46. The apparatus of claim 45, wherein the document is an extensible markup language document.

47. The apparatus of claim 45, wherein said extracted textual elements and said location paths are stored as rows in two columns in a single table.

48. The apparatus of claim 45, wherein said extracted textual elements and said location paths are stored in separate tables that are in a one-to-one relationship.

49. The apparatus of claim 45, wherein said location paths are extracted from said tree-structured document and formed into an intermediate document, and said location paths are inserted into said table by applying said intermediate document to a relational database system.

50. The apparatus of claim 49, wherein said intermediate document is an SQL script document.

51. The apparatus of claim 49, wherein said intermediate document conforms to a database extender; and said location paths are inserted in said table by applying said intermediate document to said database extender.

52. The apparatus of claim 51, wherein said intermediate document is an updategram that conforms to Microsoft Corporation's XML for SQL Server and said column is in a Microsoft Corporation SQL Server database.

53. An apparatus for storing data in a data store comprising a computer having a data store coupled thereto, wherein the data store stores data; and one or more computer programs, performed by the computer, that perform
extraction of at least one textual element from said document together with, for at least one textual element, at least one unambiguous location path corresponding to said extracted textual elements or to ancestor elements of said textual element;
insertion of said extracted textual elements into one column of a first table that also contains an identity column; and
insertion of rows into a second table, said rows comprising an unambiguous location path selected from the above unambiguous location paths, the identity of the first extracted textual element that is a descendent of said location path, and the identity of the last extracted textual element that is a descendent of said location path, said identities being the corresponding identities of said textual elements in said first table.

54. The apparatus of claim 53, wherein the document is an extensible markup language document.

55. The apparatus of claim 53, wherein said textual elements and said location paths are stored as rows in two columns in a single table.

56. The apparatus of claim 53, wherein said textual elements and said location paths are stored in separate tables that are in a one-to-one relationship.

57. The apparatus of claim 53, wherein said location paths are extracted from said tree-structured document and formed into an intermediate document, and said location paths are inserted into said table by applying said intermediate document to a relational database system.

58. The apparatus of claim 57, wherein said intermediate document is an SQL script document.

59. The apparatus of claim 57, wherein said intermediate document conforms to a database extender; and said location paths are inserted in said table by applying said intermediate document to said database extender.

60. The apparatus of claim 59, wherein said intermediate document is an updategram that conforms to Microsoft Corporation's XML for SQL Server and said column is in a Microsoft Corporation SQL Server database.

61. An apparatus for storing data in a data store comprising a computer having a data store coupled thereto, wherein the data store stores data; and one or more computer programs, performed by the computer, that perform
extracting at least one unambiguous location path corresponding to at least one textual element in said document or to at least one ancestor element of at least one textual element in said document;
inserting at least one unambiguous location path corresponding to said textual elements into one column of a first table that also contains an identity column; and
inserting at least one row into a second table, said row comprising an unambiguous location path selected from the above extracted unambiguous location paths, the identity of the location path in the first table that corresponds to the first corresponding textual element that is a descendent of said location path, and the identity of the location path in the first table that corresponds to the last corresponding textual element that is a descendent of said location path.

62. The apparatus of claim 61, wherein the document is an extensible markup language document.

63. The apparatus of claim 61, wherein said location paths are extracted from said tree-structured document and formed into an intermediate document, and said location paths are inserted into said table by applying said intermediate document to a relational database system.

64. The apparatus of claim 63, wherein said intermediate document is an SQL script document.

65. The apparatus of claim 63, wherein said intermediate document conforms to a database extender; and said location paths are inserted in said table by applying said intermediate document to said database extender.

66. The apparatus of claim 65, wherein said intermediate document is an updategram that conforms to Microsoft Corporation's XML for SQL Server and said column is in a Microsoft Corporation SQL Server database.

67. The apparatus of claim 53 wherein the rows inserted into said second table further comprise the name of the element specified by said location path.

68. The apparatus of claim 53, wherein the document is an extensible markup language document.

69. The apparatus of claim 53, wherein said location paths are extracted from said tree-structured document and formed into an intermediate document, and said location paths are inserted into said table by applying said intermediate document to a relational database system.

70. The apparatus of claim 69, wherein said intermediate document is an SQL script document.

71. The apparatus of claim 69, wherein said intermediate document conforms to a database extender; and said location paths are inserted in said table by applying said intermediate document to said database extender.

72. The apparatus of claim 71, wherein said intermediate document is an updategram that conforms to Microsoft Corporation's XML for SQL Server and said column is in a Microsoft Corporation SQL Server database.

73. The apparatus of claim 61 wherein the rows inserted into said second table further comprise the name of the element specified by said location path.

74. The apparatus of claim 73, wherein the document is an extensible markup language document.

75. The apparatus of claim 73, wherein said location paths are extracted from said tree-structured document and formed into an intermediate document, and said location paths are inserted into said table by applying said intermediate document to a relational database system.

76. The apparatus of claim 75, wherein said intermediate document is an SQL script document.

77. The apparatus of claim 75, wherein said intermediate document conforms to a database extender; and said location paths are inserted in said table by applying said intermediate document to said database extender.

78. The apparatus of claim 77, wherein said intermediate document is an updategram that conforms to Microsoft Corporation's XML for SQL Server and said column is in a Microsoft Corporation SQL Server database.

79. A computer program product comprising a program storage medium readable by a computer and embodying one or more instructions executable by the computer to perform method steps for storing data in a data store connected to a computer, the method comprising
extracting at least one unambiguous location path from said tree-structured document, and
inserting said unambiguous location path into a table.

80. The computer program product of claim 79, wherein the document is an extensible markup language document.

81. The computer program product of claim 79, wherein said location path is extracted from said tree-structured document and formed into an intermediate document, and said location path is inserted into said table by applying said intermediate document to a relational database system.

82. The computer program product of claim 81, wherein said intermediate document is an SQL script document.

83. The computer program product of claim 81, wherein said intermediate document conforms to a database extender; and said location path is inserted in said table by applying said intermediate document to said database extender.

84. The computer program product of claim 83, wherein said intermediate document is an updategram that conforms to Microsoft Corporation's XML for SQL Server and said column is in a Microsoft Corporation SQL Server database.

85. A computer program product comprising a program storage medium readable by a computer and embodying one or more instructions executable by the computer to perform method steps for storing data in a data store connected to a computer, the method comprising
extracting at least one textual element from said tree-structured document together with unambiguous location paths corresponding to the extracted textual element, and
inserting said extracted textual elements into one column of a table and said location paths into a second column that is in a one-to-one relationship to the first column.

86. The computer program product of claim 85, wherein the document is an extensible markup language document.

87. The computer program product of claim 85, wherein said extracted textual elements and said location paths are stored as rows in two columns in a single table.

88. The computer program product of claim 85, wherein said extracted textual elements and said location paths are stored in separate tables that are in a one-to-one relationship.

89. The computer program product of claim 85, wherein said location paths are extracted from said tree-structured document and formed into an intermediate document, and said location paths are inserted into said table by applying said intermediate document to a relational database system.

90. The computer program product of claim 89, wherein said intermediate document is an SQL script document.

91. The computer program product of claim 89, wherein said intermediate document conforms to a database extender; and said location paths are inserted in said table by applying said intermediate document to said database extender.

92. The computer program product of claim 91, wherein said intermediate document is an updategram that conforms to Microsoft Corporation's XML for SQL Server and said column is in a Microsoft Corporation SQL Server database.

93. A computer program product comprising a program storage medium readable by a computer and embodying one or more instructions executable by the computer to perform method steps for storing data in a data store connected to a computer, the method comprising
extracting at least one textual elementfrom at least one tree-structured document together with, for at least one textual element, at least one unambiguous location path corresponding to said extracted textual elements or to ancestor elements of said textual element,
inserting said extracted textual elements into one column of a first table that also contains an identity column; and
inserting rows into a second table, said rows comprising an unambiguous location path selected from the above unambiguous location paths, the identity of the first extracted textual element that is a descendent of said location path, and the identity of the last extracted textual element that is a descendent of said location path, said identities being the corresponding identities of said textual elements in said first table.

94. The computer program product of claim 93, wherein the document is an extensible markup language document.

95. The computer program product of claim 93, wherein said location paths are extracted from said tree-structured document and formed into an intermediate document, and said location paths are inserted into said table by applying said intermediate document to a relational database system.

96. The computer program product of claim 95, wherein said intermediate document is an SQL script document.

97. The computer program product of claim 95, wherein said intermediate document conforms to a database extender; and said location paths are inserted in said table by applying said intermediate document to said database extender.

98. The computer program product of claim 97, wherein said intermediate document is an updategram that conforms to Microsoft Corporation's XML for SQL Server and said column is in a Microsoft Corporation SQL Server database.

99. A computer program product comprising a program storage medium readable by a computer and embodying one or more instructions executable by the computer to perform method steps for storing data in a data store connected to a computer, the method comprising
extracting at least one unambiguous location path corresponding to at least one textual element in said document or to at least one ancestor element of at least one textual element in said document;
inserting at least one unambiguous location path corresponding to said textual elements into one column of a first table that also contains an identity column; and
inserting at least one row into a second table, said row comprising an unambiguous location path selected from the above extracted unambiguous location paths, the identity of the location path in the first table that corresponds to the first corresponding textual element that is a descendent of said location path, and the identity of the location path in the first table that corresponds to the last corresponding textual element that is a descendent of said location path.

100. The computer program product of claim 99, wherein the document is an extensible markup language document.

101. The computer program product of claim 99, wherein said location paths are extracted from said tree-structured document and formed into an intermediate document, and said location paths are inserted into said table by applying said intermediate document to a relational database system.

102. The computer program product of claim 101, wherein said intermediate document is an SQL script document.

103. The computer program product of claim 101, wherein said intermediate document conforms to a database extender; and said location paths are inserted in said table by applying said intermediate document to said database extender.

104. The computer program product of claim 103, wherein said intermediate document is an updategram that conforms to Microsoft Corporation's XML for SQL Server and said column is in a Microsoft Corporation SQL Server database.

105. The computer program product of claim 93 wherein the rows inserted into said second table further comprise the name of the element specified by said location path.

106. The computer program product of claim 105, wherein the document is an extensible markup language document.

107. The computer program product of claim 105, wherein said location paths are extracted from said tree-structured document and formed into an intermediate document, and said location paths are inserted into said table by applying said intermediate document to a relational database system.

108. The computer program product of claim 107, wherein said intermediate document is an SQL script document.

109. The computer program product of claim 107, wherein said intermediate document conforms to a database extender; and said location paths are inserted in said table by applying said intermediate document to said database extender.

110. The computer program product of claim 109, wherein said intermediate document is an updategram that conforms to Microsoft Corporation's XML for SQL Server and said column is in a Microsoft Corporation SQL Server database.

111. The computer program product of claim 99 wherein the rows inserted into said second table further comprise the name of the element specified by said location path.
extracting textual elements from said document together with the unambiguous location paths corresponding to said textual elements and the ancestor elements of said textual elements;
assigning identifiers to said textual elements;
inserting rows into a table, said rows comprising an unambiguous location path selected from the above unambiguous location paths, the name of the element specified by said location path, the identifier of the first textual element that is a descendent of said location path, and the identifier of the last textual element that is a descendent of said location path.

112. The computer program product of claim 111, wherein the document is an extensible markup language document.

113. The computer program product of claim 111, wherein said location paths are extracted from said tree-structured document and formed into an intermediate document, and said location paths are inserted into said table by applying said intermediate document to a relational database system.

114. The computer program product of claim 113, wherein said intermediate document is an SQL script document.

115. The computer program product of claim 113, wherein said intermediate document conforms to a database extender; and said location paths are inserted in said table by applying said intermediate document to said database extender.

116. The computer program product of claim 115, wherein said intermediate document is an updategram that conforms to Microsoft Corporation's XML for SQL Server and said column is in a Microsoft Corporation SQL Server database.

117. A method of obtaining data comprising:
selecting a database, wherein the database includes data stored from at least one tree-structured document in a data store connected to a computer, said data stored by extracting at least one unambiguous location paths corresponding to at least one textual element of at least one tree-structured document, and inserting said extracted location paths into a table,
making a search request; and
fetching the data obtained from the selected database in response to the search request.

118. The method of claim 117, further comprising establishing a data connection for making the search request.

119. The method of claim 117, wherein the document is an extensible markup language document.

120. The method of claim 117, wherein said location paths are extracted from said tree-structured document and formed into an intermediate document, and said location paths are inserted into said table by applying said intermediate document to a relational database system.

121. The method of claim 120, wherein said intermediate document is an SQL script document.

122. The method of claim 120, wherein said intermediate document conforms to a database extender; and said location paths are inserted in said table by applying said intermediate document to said database extender.

123. The method of claim 122, wherein said intermediate document is an updategram that conforms to Microsoft Corporation's XML for SQL Server and said column is in a Microsoft Corporation SQL Server database.

124. A method of obtaining data comprising:
selecting a database, wherein the database includes data stored from a tree-structured document in a data store connected to a computer, said data stored by extracting at least one textual element from said tree-structured document together with unambiguous location paths corresponding to the extracted textual element, and inserting said extracted textual elements into one column of a table and said location paths into a second column that is in a one-to-one relationship to the first column,
making a search request; and
fetching the data obtained from the selected database in response to the search request.

125. The method of claim 124, further comprising establishing a data connection for making the search request.

126. The method of claim 124, wherein the document is an extensible markup language document.

127. The method of claim 124, wherein said extracted textual elements and said location paths are stored as rows in two columns in a single table.

128. The method of claim 124, wherein said extracted textual elements and said location paths are stored in separate tables that are in a one-to-one relationship.

129. The method of claim 124, wherein said location paths are extracted from said tree-structured document and formed into an intermediate document, and said location paths are inserted into said table by applying said intermediate document to a relational database system.

130. The method of claim 129, wherein said intermediate document is an SQL script document.

131. The method of claim 129, wherein said intermediate document conforms to a database extender; and said location paths are inserted in said table by applying said intermediate document to said database extender.

132. The method of claim 131, wherein said intermediate document is an updategram that conforms to Microsoft Corporation's XML for SQL Server and said column is in a Microsoft Corporation SQL Server database.

133. A method of obtaining data comprising:
establishing a data communications connection with a computer which has access to a computer program product readable by at least one computer capable of executing the computer program product, said computer program product embodying one or more instructions to perform method steps for storing data in a data store connected to a computer, the method steps including the extraction of textual elements from at least one tree-structured document together with unambiguous location paths corresponding to said textual elements, and the insertion of said location paths into a table,
making a search request; and
fetching the data obtained from the selected database in response to the search request.

134. The method of claim 133, further comprising establishing a data connection for making the search request.

135. The method of claim 133, wherein the document is an extensible markup language document.

136. The method of claim 133, wherein said location paths are extracted from said tree-structured document and formed into an intermediate document, and said location paths are inserted into said table by applying said intermediate document to a relational database system.

137. The method of claim 136, wherein said intermediate document is an SQL script document.

138. The method of claim 136, wherein said intermediate document conforms to a database extender; and said location paths are inserted in said table by applying said intermediate document to said database extender.

139. The method of claim 138, wherein said intermediate document is an updategram that conforms to Microsoft Corporation's XML for SQL Server and said column is in a Microsoft Corporation SQL Server database.

140. A method of obtaining data comprising:
establishing a data communications connection with a computer which has access to a computer program product readable by at least one computer capable of executing the computer program product, said computer program product embodying one or more instructions to perform method steps for storing data in a data store connected to a computer, the method steps including the extraction of textual elements from at least one tree-structured document together with unambiguous location paths corresponding to said textual elements, and the insertion of said textual elements into one column of a table and location paths into a second column that is in a one-to-one relationship to the first column,
making a search request; and
fetching the data obtained from the selected database in response to the search request.

141. The method of claim 140, further comprising establishing a data connection for making the search request.

142. The method of claim 140, wherein the document is an extensible markup language document.

143. The method of claim 140, wherein said textual elements and said location paths are stored as rows in two columns in a single table.

144. The method of claim 140, wherein said textual elements and said location paths are stored in separate tables that are in a one-to-one relationship.

145. The method of claim 140, wherein said location paths are extracted from said tree-structured document and formed into an intermediate document, and said location paths are inserted into said table by applying said intermediate document to a relational database system.

146. The method of claim 145, wherein said intermediate document is an SQL script document.

147. The method of claim 146, wherein said intermediate document conforms to a database extender; and said location paths are inserted in said table by applying said intermediate document to said database extender.

148. The method of claim 147, wherein said intermediate document is an updategram that conforms to Microsoft Corporation's XML for SQL Server and said column is in a Microsoft Corporation SQL Server database.

149. A computer database product comprising a data storage medium readable by a computer and embodying a data store comprising at least one table that comprises at least one unambiguous location path extracted from a tree-structured document.

150. A computer database product according to claim 149 wherein the tree-structured document is in a markup language that conforms to the extensible markup language.

151. A computer database product comprising a data storage medium readable by a computer and embodying a data store comprising a first column in a table comprising textual elements extracted from a tree-structured document and a second column in a table comprising unambiguous location paths that are extracted from said tree-structured document and that correspond to said textual elements, said textual elements and said location paths being in one-to-one correspondence.

152. A computer database product according to claim 151 wherein the tree-structured document is in a markup language that conforms to the extensible markup language.

153. A computer database product comprising a data storage medium readable by a computer and embodying a data store comprising
a column in a first table comprising at least one textual element extracted from a tree-structured document, said first table also comprising an identity column; and
a second table comprising at least one row that comprises unambiguous location paths that are extracted from said tree-structured document and that correspond to said textual elements or to an ancestor element of said textual elements, the identity from said first table that corresponds to the first textural element that is a descendant of said location path, and the identity from said first table that corresponds to the last textual element that is descendant of said location path.

154. A computer database product according to claim 153 wherein the tree-structured document is in a markup language that conforms to the extensible markup language.

155. A computer database product according to claim 153 wherein said row of said second table further comprises the name of the element specified by said location path.

156. A computer database product comprising a data storage medium readable by a computer and embodying a data store comprising
a column in a first table comprising at least one unambiguous location path that corresponds to a textual element in a tree-structured document, said first table also comprising an identity column; and
a second table comprising at least one row that comprises unambiguous location paths that are extracted from said tree-structured document and that correspond to said textual elements or to an ancestor element of said textual elements, the identity from said first table that corresponds to the unambiguous location path of the first textural element that is a descendant of said location path, and the identity from said first table that corresponds to the unambiguous location path of the last textual element that is descendant of said location path.

157. A computer database product according to claim 156 wherein the tree-structured document is in a markup language that conforms to the extensible markup language.

158. A computer database product according to claim 156 wherein said row of said second table further comprises the name of the element specified by said location path.
